(19) United States
(12) Patent Application Publication
(10) Pub. No.: US 2022/0044504 A1
(43) Pub. Date: Feb. 10, 2022

(54) SMART LICENSE PLATE VAULT

(71) Applicant: Biig Technologies Inc., Burlingame, CA (US)

(72) Inventors: Charlene Consolacion, Tracy, CA (US); Janno Stern, Tallinn (EE); Jaan Viru, Tallinn (EE)

(21) Appl. No.: 17/500,562

(22) Filed: Oct. 13, 2021

Related U.S. Application Data
(63) Continuation-in-part of application No. 16/716,407, filed on Dec. 16, 2019.
(60) Provisional application No. 62/780,260, filed on Dec. 16, 2018.

(51) Int. Cl. G07C 9/00; G07C 9/22

(52) U.S. Cl. CPC G07C 9/00309; G07C 9/00912; G07C 2009/00936; G07C 2009/00412; G07C 9/22

(57) ABSTRACT

A smart license plate vault is disclosed. The smart license plate vault securely holds small objects, such as a vehicle key, while resembling a license plate mounting platform. The smart license plate vault establishes a communication connection with a user device via the local transceiver of the smart license plate vault and receives a signed command to access the vault from the user device via the communication connection, verifies authenticity of the signed command, and unlocks the vault only upon determining that the signed command is authentic

### CROSS REFERENCE TO RELATED APPLICATION

The present application is a continuation-in-part of U.S. patent application Ser. No. 16/716,407 entitled “SMART VAULT WITH SECURITY SYSTEM AFFIX TO REAR OR FRONT OF LICENSE PLATE LOCATION OUTSIDE ANY VEHICLE TO ENABLE REMOTE ACCESS TO CARS” filed on Dec. 16, 2019, which claims priority to provisional application No. 62/780,260 entitled “SMART VAULT WITH SECURITY SYSTEM AFFIX TO REAR OR FRONT OF LICENSE PLATE LOCATION OUTSIDE ANY VEHICLE TO ENABLE REMOTE ACCESS TO CARS” filed on Dec. 16, 2018, each of which is assigned to the assignee hereof and expressly incorporated by reference herein.

### BACKGROUND

### Field of Use

The present application relates to the automotive industry. More specifically, the present application relates to a method, apparatus and system for allowing remote access.

### Description of the Related Art

It is sometimes necessary or desirable to store a vehicle key or key fob outside of the vehicle such as for backup (e.g., in case a primary key or key fob is lost) or to provide access to the vehicle by others (e.g., renters, fleet operators, delivery persons, valets, etc.).

One way to store a vehicle key or key fob outside of the vehicle is to hide a vehicle's key somewhere outside the vehicle so that an authorized person may access the vehicle. For example, a car key may be “hidden” by placing it on top of one of the car's tires, which is generally out of sight of people walking by but, of course, vulnerable to anyone nefariously looking for such a key, knowing that people sometimes use this method for purposes of car exchange.

Another way that has been used to store keys outside a vehicle is to use a magnetic “vault.” Such vaults typically comprise a container for holding a key and a strong magnet that allows placement in more inconspicuous areas of a vehicle, such as inside a wheel well or underneath a bumper. However, these vaults are still relatively easy to find by unauthorized persons.

In order to make a vault less accessible to unauthorized persons, some car manufacturers offer a vault that is pertinently affixed inside vehicles, such as under the hood, and electronically controlled via a wired connection to the vehicle, such as via an industry-standard OBDII connector. However, this method of key concealment is expensive and not available to vehicles that are not already equipped with such a device from the manufacturer.

More recently, vaults have been designed for placement behind license plates. For example, U.S. Pat. No. 7,866,071 describes a primitive “lock box” with a weather-proof compartment and a license plate holder that mounts to a license plate bracket. The license plate holder is pivotally connected to a “rigid panel” mounted to a license plate bracket, that exposes a vault and mechanical lock. A mechanical key operates the lock to allow access to the vault, where a key may be stored. However, in order to allow third party access to the vehicle, the mechanical key much be physically exchanged somehow with the third party, or a duplicate key must be provided. Having to exchange physical keys is a major drawback of this kind of vault.

### SUMMARY

In accordance with one embodiment, a system comprises a smart license plate vault comprising a base portion, the base portion comprising a vault, an electronic locking mechanism for selectively locking and unlocking the vault, a local transceiver, and a processor in communication with the electronic locking mechanism and the local transceiver for operating the smart license plate vault; wherein the smart license plate vault establishes a communication connection with a user device via the local transceiver of the smart license plate vault; and the smart license plate vault receives a digitally signed command to access the vault from the user device via the communication connection, verifies authenticity of the digitally signed command, and unlocks the vault only upon determining that the digitally signed command is authentic.

In various alternative embodiments, the smart license plate vault may perform an initial pairing with the user device including an exchange of public keys via the communication connection. The communication connection may include a Bluetooth® communication connection or other appropriate communication connection. The system may further include the user device, in which case the user device may authenticate the user (e.g., by at least one of a username, a password, a fingerprint scan, a challenge, or two-factor authentication) and only generate the digitally signed command upon determining that the user is authentic. Additionally or alternatively, the user device may generate the digitally signed command to access the vault by generating a command and sending the command to a remote server that digitally signs the command and returns the digitally signed command to the user device, or the user device may generate the digitally signed command to access the vault by generating a command and digitally signing the command using a token stored on the user device.

In accordance with another embodiment, a method comprises establishing a communication connection between a smart license plate vault and a user device via a local transceiver of the smart license plate vault; receiving, by the user device, a user request to access the vault; generating, by the user device, a digitally signed command to access the vault and transmitting the digitally signed command to the smart license plate vault via the communication connection; and verifying, by the smart license plate vault, authenticity of the digitally signed command and unlocking the vault only upon determining that the digitally signed command is authentic.

In various alternative embodiments, the smart license plate vault and the user device may perform an initial pairing including an exchange of public keys via the communication connection. The communication connection may include a Bluetooth® communication connection or other appropriate communication connection. The user device may authenticate the user (e.g., by at least one of a username, a password, a fingerprint scan, a challenge, or two-factor authentication) and only generate the electronically/digitally signed command upon determining that the user is authentic. The user device may generate the digitally signed command to access the vault by generating a command and sending the command to a remote server that digitally signs the command and returns the digitally signed command to the user device, or, alternatively, may generate the digitally signed command to access the vault by generating a command and digitally signing the command using a token stored on the user device.

In accordance with another embodiment, a smart license plate vault comprises a base portion, the base portion comprising a vault, an electronic locking mechanism for selectively locking and unlocking the vault, a local transceiver, and a processor in communication with the electronic locking mechanism and the local transceiver and coupled to a memory containing instructions executable by the processor to cause the processor to establish a communication connection with a user device; receive, from the user device, a digitally signed command to access the vault via the communication connection; verify authenticity of the digitally signed command; and unlock the vault only upon determining that the digitally signed command is authentic.

In various alternative embodiments, the smart license plate vault and the user device may perform an initial pairing including an exchange of public keys via the communication connection. The communication connection may include a Bluetooth® communication connection or other appropriate communication connection.

Additional embodiments may be disclosed and claimed.

### BRIEF DESCRIPTION OF THE DRAWINGS

The features, advantages, and objects of the embodiments of the present invention will become more apparent from the detailed description as set forth below, when taken in conjunction with the drawings in which like referenced characters identify correspondingly throughout, and wherein:

FIG. 1 shows a perspective view of one embodiment of a smart license plate vault in an open position;

FIG. 2 is a left side, plan view of the smart license plate vault of FIG. 1, shown in a closed position, highlighting a slanted profile of the smart license plate vault;

FIG. 3 is a functional block diagram of one embodiment of the smart license plate vault as shown in FIGS. 1 and 2; and

FIG. 4 is a block diagram showing one embodiment of a system in which the smart license plate vault of FIGS. 1, 2 and 3 may be used.

FIG. 5 is a logic flow diagram showing pairing of the smart license plate vault with a user device to allow the user to access the smart license plate vault through an application on the user device, in accordance with various embodiments.

FIG. 6 is a logic flow diagram showing how battery resources can be preserved by activating a mobile communication connection when needed, in accordance with various embodiments.

FIG. 7 is a logic flow diagram for selectively transmitting location data associated with the smart license plate vault, in accordance with various embodiments.

FIG. 8 is a logic flow diagram for intrusion detection and alert, in accordance with various embodiments.

FIG. 9 is a logic flow diagram for generation of a low power notification to prompt a user to replace or recharge the battery of a smart license plate vault, in accordance with various embodiments.

FIGS. 10A-10N are screenshots of an example application that a user can use to interact with the smart license plate vault, in accordance with various embodiments.

FIGS. 11A-11K are screenshots of an example web-based portal 1100 that a user can use to access, manage and oversee a vehicle(s) equipped with a smart license plate vault that is associated with the user, in accordance with various embodiments.

### DETAILED DESCRIPTION

The embodiments described herein relate to a universal smart license plate vault that is mounted between a vehicle bumper and a vehicle license plate. The smart license plate vault can be mounted to virtually any vehicle make or model. A movable portion of the smart license plate vault secures the vehicle license plate, and this movable portion is connected to a base portion of the smart license plate vault via a hinge. To access a storage compartment in the base portion, the movable portion is rotated away from the base portion, exposing the lockable compartment and, in one embodiment, a user interface in the form of a pad that allows access to the lockable compartment. The smart license plate vault can be used to securely store a vehicle key, and/or other items, for access to the vehicle by authorized persons. For example, a vehicle key can be locked inside the vault, and the vault opened using a predetermined access code provided by a vehicle owner to an authorized person. The authorized person could be a delivery driver in the case of a delivery service that delivers packages or other items to an unattended, locked vehicle. The delivery driver can access an interior area or a trunk of the vehicle after retrieving the vehicle key from the vault. Applications for the embodiments described herein include the aforementioned package delivery services, car rental services, roadside assistance, etc.

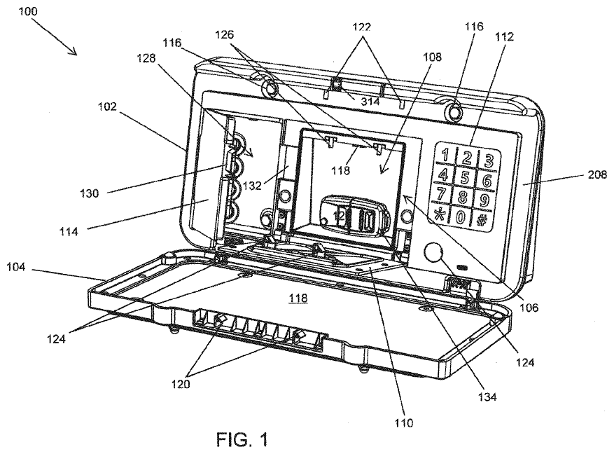

FIG. 1 shows a perspective view of one embodiment of a smart license plate vault 100 in an open position, comprising base portion 102, movable portion 104, vault 106 comprising storage compartment 108 and cover plate 110, user interface 112, and battery 114.

Base portion 102 is sized and shaped slightly larger than a standard vehicle license plate and mounted to a vehicle bumper (or to a license plate mounting plate affixed to a vehicle bumper) in place of where a license plate typically resides. Base portion 102 is mounted to a vehicle bumper, typically via bolts that are passed through holes 116 located along a top portion of base portion 102 to coincide with existing mounting retainers found on the bumper (or a license plate holding plate) normally used to receive bolts for mounting a license plate.

Movable portion 104 is also sized and shaped in the form of a standard license plate, comprising a front side (not shown) for mounting a license plate, and a recessed back side 118. Movable portion 104, in this embodiment, is rotatably coupled to base portion 102 via two rotation devices, such as hinges, flexible material, etc., located at a bottom portion of base portion 104 and movable portion 104. In other embodiments, a single hinge could be used alternatively, and in yet still other embodiments, the hinge(s) could be located along a top portion of base portion 102 and movable portion 104, or on either the left or right sides of base portion 102 and movable portion 104. In yet still another embodiment, movable cover 104 is removably coupled to base portion 102 using no rotation devices. In this embodiment, movable cover 104 is secured to base portion 102 using one of any number of temporary fastening techniques known in the art, such as Velcro®, snaps, friction, or other means, and is detached completely from base portion 102 when accessing compartment user interface 112 and storage compartment 108.

When smart license plate vault is not in use, movable portion 104 is manually rotated about the hinges and received by base portion 102, secured to base portion 102 via one or more temporary fastening devices, such as deformable latches 120 in cooperation with receiving slots 122. Of course, any other temporary mechanical fasteners could be used in the alternative, such as Velcro, screws, bolts, clips, etc. When movable portion 104 is secured to base portion 102, the license plate is displayed in a way that meets jurisdictional license plate viewing laws, while largely concealing the presence of smart license plate vault 100.

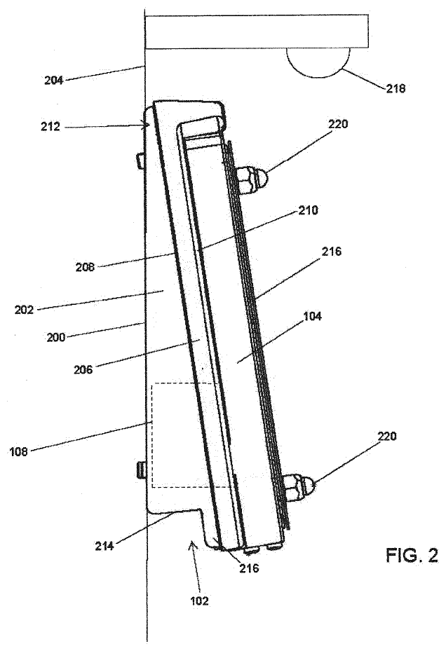

FIG. 2 is a left side, plan view of smart license plate vault 100 in a closed position, highlighting a slanted profile of smart license plate vault 100. The base portion 102 comprises a mounting plate 200 and two, triangular sides each extending perpendicularly from mounting plate 200, one shown as triangular side 202 and a similar triangular side on the right side of mounting plate 200 (not shown in this view). Mounting plate 200 is in contact with a vehicle bumper 204 (or license plate mounting plate affixed to a vehicle bumper). Mounting plate 200 comprises two or more holes positioned to coincide with mounting fasteners found on the vehicle bumper or license plate mounting plate, and screws or bolts are typically used to secure mounting plate 200 to the vehicle bumper or license plate mounting plate via the screws or bolts.

A plate 206 is mounted to the two, triangular sides via a rear surface 208 of plate 206, plate 206 comprising a rectangular shape mounted to a hypotenuse of triangular side 202, extending past the two, triangular sides on each end. A front surface 210 of plate 206 is viewable by a user when movable portion 104 is placed into the open position. Plate 206 comprises one or more depressions for securing various components of smart license plate vault 100, such as battery 114, storage compartment 108 and user interface 112. One or more of the depressions may extend into a cavity formed by mounting plate 200, the two, triangular sides and plate 206. For example, storage compartment 108 is shown in hidden lines as extending into plate 206 and into the cavity.

The dimensions of triangular side 202 determine an angle 212 located at the top of triangular side 202. Angle 212 is formed as a result of the height of mounting plate 200 and a length of a lower extension 214 (plus an additional amount equal to a thickness of bottom protrusion 216 of triangular side 202). In the embodiment shown in FIG. 2, angle 212 is approximately 20 degrees, which causes plate 206 to also be slanted at a 20 degree angle. In other embodiments, angle 212 may be greater or less than 20 degrees.

The slanted inclination of plate 206 provides at least two, unique attributes to smart license plate vault 100. First, it allows a vehicle license plate light 218 mounted above smart license plate vault 100 to illuminate a viewable plane of the vehicle license plate 216, i.e., the alpha-numeric sequence of the license plate. License plate 216 is affixed to movable portion 104 via two or more fasteners 220, as shown. License plate 216 is also slanted at angle 212 degrees as movable portion 104 is also slanted at the same angle as angle 212 when movable portion 104 is secured against base portion 102. This arrangement allows a top portion of license plate 216 to be close to vehicle bumper 204, thus allowing vehicle license plate light 218 to illuminate the entire surface of license plate 216.

The other advantage of the slanted design of smart license plate vault 100 is that it allows a space for things such as battery 114, storage compartment 108 and user interface 112 to be flush-mounted with front surface 210 of plate 206.

Referring back to FIG. 1, a user may approach a vehicle having smart license plate vault 100 already installed, for example, on a rear bumper of the vehicle, releasing movable portion 104 from base portion 102 by, in this embodiment, releasing tabs 120 that are held by slots 122, rotating movable portion 104 downwards to a position as shown in FIG. 1 to expose plate 206, battery 114, vault 106, user interface 112, and power port 124. The user may then unlock vault 106 using a predetermined code entered into user interface 112 which, in this embodiment, comprises a keypad. In other embodiments, another type of user interface could be used, such as a microphone to detect a predetermined code word uttered by the user, a fingerprint scanner, a retina scanner, a camera, or some other device to accept some form of authorization input from a user. In these other examples, the authorized input may comprise a code word or phrase, a fingerprint of the user or another user(s) authorized to operate vault 106, the user or other authorized user's retina, a face of the user or other authorized user(s), or a bar code or QR code in the case of a camera, etc.

When the user enters the correct code, or otherwise provides predetermined user input to unlock vault 106, tabs 124 are released as one or more mechanical locking mechanisms 126, such as a movable bolt, latch, cam, or other physical obstruction, are retracted by an electric motor (not shown), allowing cover plate 110 to open. Other well-known mechanical or electro-mechanical locking devices could be used in the alternative. The user may then place one or more small objects, such as a vehicle key, vehicle FOB, home key, cell phone, or other objections into storage compartment 108, then close and lock cover plate 110, typically by entering the predetermined code or other user input via user interface 112, or by an mechanical relationship between tabs 124 and mechanical locking mechanisms 126, such as a the structure of tabs 124 constructed of a semi-bendable material that deforms tabs 124 against mechanical locking mechanisms 126 as a slanted portion of tabs 124 operate against mechanical locking mechanisms 126, and then clearing the slanted portion, locking a flat portion of tabs 124 against the mechanical locking mechanisms 126.

In another embodiment, the user may use a smart phone or some other personal communication device, such as a smart watch or other wearable device, to unlock and lock vault 106. In this embodiment, the personal communication device may execute a software application or “app” that provides the user with locking and unlocking capabilities, as well as other use functions, such as remotely providing a location of the vehicle, notifications when particular events occur in association with the vehicle, such as when a sound is detected near the vehicle, when the vehicle experiences a shock, vibration, acceleration or deceleration indicative of a break-in or collision of the vehicle, provide temperature readings of the ambient air near the vehicle, etc. The personal communication device may be wirelessly coupled with smart license plate vault 100 using either wide-area communication technology when the user is remotely located from the vehicle (such as over satellite or cellular data networks), local-area communication techniques when the user is proximate to the vehicle (such as using Bluetooth®, BLE, NFC, or some other direct wireless communication technology), or both.

After a key, FOB or other object is secured within vault 106, the user generally closes movable portion 104 against base portion 102, holding license plate 216 is a slanted position relative to the vehicle.

The user may then provide the predetermined code to a second user, for example a delivery driver, for later delivery of a package or other items to the vehicle when the vehicle is unattended by the user, for the second user to rent the user's vehicle, for unattended vehicle roadside repair, or for some other purpose. The second user could, alternatively, comprises someone who will be renting the vehicle from the user, a roadside assistance employee who may deliver fuel, fix a flat tire, change a vehicle battery, or some other person who may require access to the vehicle when the vehicle is unattended by the user. The second user unlocks vault 106 using the predetermined code provided by the user, then uses the key, FOB or other object to utilize the vehicle for a particular purpose authorized by the user. Other features of various embodiments will be described later here.

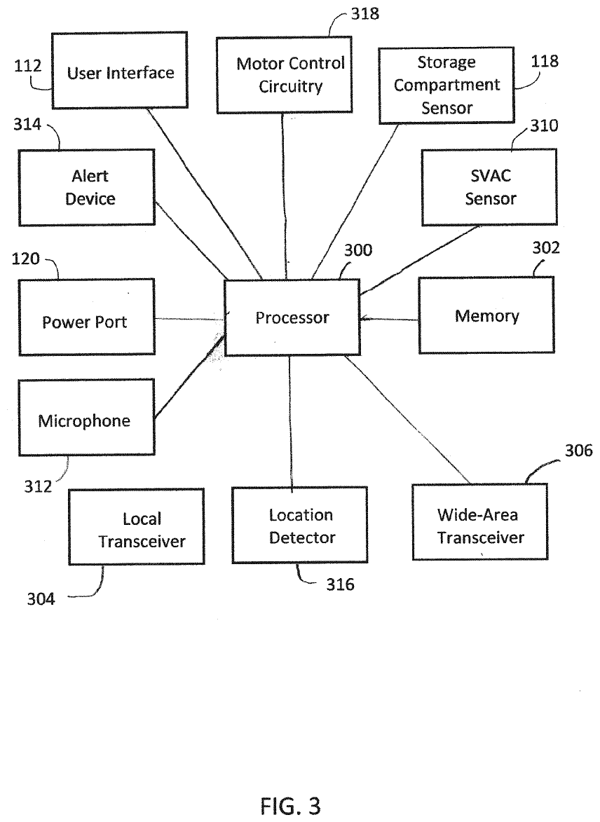

FIG. 3 is a functional block diagram of one embodiment of smart license plate vault 100, comprising processor 300, memory 302, local transceiver 304, wide-area transceiver 306, user interface 112, storage compartment sensor 119, shock, vibration, acceleration, and/or compass heading (SVACA) sensor 310, microphone 312, alert device 314, power port 120, location detector 316 and motor control circuitry 318. It should be understood that not all of the functional blocks shown in FIG. 3 are required for operation of smart license plate vault 100 (for example, in some embodiments, SVAC 310 and vehicle bus interface 316 are not used), that the functional blocks may be connected to one another in a variety of ways, and that not all functional blocks necessary for operation of smart license plate vault 100 are shown (such as battery 114, data busses, or other well-known technology), for purposes of clarity.

Processor 300 is configured to provide general operation of smart license plate vault 100 by executing processor-executable instructions stored in memory 302, for example, executable code. Processor 300 typically comprises one or more general purpose processors, such as an ADuC7024 analog microcontroller manufactured by Analog Devices, Inc. of Norwood Mass., although any one of a variety of microprocessors, microcomputers, and/or microcontrollers may be used alternatively, selected on the basis of size, power consumption and cost, among other factors.

Memory 302 comprises one or more information storage devices, such as RAM, ROM, EEPROM, flash memory, or virtually any other type of electronic, optical, or mechanical memory device. Memory 302 is used to store the processor-executable instructions for operation of smart license plate vault 100 as well as any information used by processor 300, such as sound/shock/vibration thresholds, identification information (i.e., of a vehicle to which smart license plate vault 100 is attached or a serial number or other identification information of smart license plate vault 100), authorization information (such as a predetermined code, code word, QR code, barcode, digital image, etc.), status information (such as “vault door open/closed”, movable portion 104 open/closed, vehicle moving/not moving, sound recordings captured via microphone 316, photographs, video or other sensor data captured by storage compartment sensor 310, and dates/times associated with each of the aforementioned information that may be stored in memory 302. In some embodiments, at least a portion of memory 302 is incorporated into processor 300.

User interface 112 is used to allow a user to operate smart license plate vault 100, used to provide authorization information to processor 300 and, in some embodiments, provide feedback to a user, for example, that authorization information provided to user interface 112 was successfully, or unsuccessfully, processed. In one embodiment, user interface 112 may comprises a keypad comprising a number of pushbuttons or, in another embodiment, a touchscreen displaying a variety of symbols, such as numbers and/or letters. In other embodiments, user interface 112 could comprise one or more pushbuttons, switches, knobs, or some other mechanical device. In some embodiments, user interface 112 may comprise a microphone for receiving a predetermined code word verbally and converting the predetermined code word into an electronic signal for processing by processor 300. In yet still other embodiments, user interface 112 could comprise a digital camera for capturing digital images of users' retina, face, a QR code, a barcode, or some other visual authorization to operate smart license plate vault 100. In any of the above cases, processor 300 compares input received from user interface 112 and compares the input to one or more access codes or, more generally, access criteria stored in memory 302 to determine if a match is found. If a match is found, processor 300 causes motor control circuitry 318 to move mechanical locking mechanism 126 to unlock, or lock, vault 106.

User interface 112 could additionally comprise a speaker to provide audio feedback in response to entries to user interface 112, and/or an electronic display to provide visual feedback, such as a touchscreen, one or more LEDs, etc. A speaker could also be used to provide audio instructions to an authorized third party accessing smart license plate vault 100, such as pre-recorded instructions stored in memory 302 on how to operate the vehicle, where a jack or wheel lock may be located, fueling instructions, package delivery instructions, etc. A speaker may also be used to provide real-time communications between a user and an authorized third party as the authorized third party operates smart license plate vault 100. For example, smart license plate vault 100 could send an alert to a user that vault 106 has been opened. In response, the user may speak to the authorized third party using the user's client device (i.e., smart phone), where the user's voice is provided to the authorized third party via the speaker. Two-way voice communications may also be possible, using a microphone on smart license plate vault 100. In yet still another embodiment, no user interface is used. In this embodiment, operation of smart license plate vault 100 is accomplished using a computer, smartphone, or some other electronic communication device.

Local transceiver 304 comprises circuitry necessary to transmit and receive wireless signals directly with a user device, such as a smartphone, when a user is within range of local transceiver 304, for example, when a user approaches smart license plate vault 100 to store or retrieve on object from vault 106. Local transceiver 304 comprises circuitry in accordance with one of any number of well-known local communication technologies, such as Bluetooth®, BLE, Wi-Fi, Zigbee, Z-Wave, X-10, infra-red, ultrasonic and any other local communication technology suitable for use in a battery-powered device.

Wide area transceiver 306 comprises circuitry necessary to transmit and receive wireless signals with a user device, such as a computer, smartphone or other electronic communication device, when a user is remotely located from smart license plate vault 100. Wide area transceiver 306 comprises circuitry in accordance with one of any number of well-known wide area communication technologies, such as one of any number of cellular data technologies (such as 4G LTE, UMTS, etc.) or any other wide area communication technology suitable for use in a battery-powered device.

Storage compartment sensor 119 is used to detect the presence of an objection inside storage compartment 108 so that one or more users know when an object is presently being stored within storage compartment 108. In some embodiments, storage compartment sensor 119 may additionally determine one or more physical properties, parameters, attributes, and/or characteristics of one or more objects stored inside storage compartment 108. In one embodiment, storage compartment sensor 119 comprises a digital camera and a light source (such as an LED) to record one or more digital images of storage compartment 108, including any object that may be stored therein. In other embodiments, storage compartment sensor 119 comprises an ultrasonic or infra-red detector, a capacitance or inductance detector to detect changes in an RF field emitted by such a capacitance or inductance detector when an object is placed into storage compartment 108. In one embodiment using a digital camera and a light source, processor 300 causes the light source to illuminate, cause the digital camera to capture a digital image of storage compartment 108, then extinguish the light source after processor 300 determines that cover plate 110 has been closed, i.e., immediately after cover plate 110 has been closed or a predetermined time period after such closure has been detected. Such detection can be accomplished by processor 300 coupled to a simple switch (not shown) incorporated into vault 106 that activates when cover 100 is closed against storage compartment 108. In another embodiment, processor 300 causes storage compartment sensor 119 to record information (such as a digital image, capacitance or inductance readings, etc.) at predetermined time intervals, such as once every 30 minutes. In yet still another embodiment, processor 300 causes storage compartment sensor 119 to record information upon the occurrence of a predetermined event, such as vehicle movement (as detected by a shock, vibration, accelerometer and/or compass described later herein), or upon opening of cover plate 110 in order to determine what was inside storage compartment 108 immediately before an object has been removed from storage compartment 108. In yet still further embodiments, storage compartment sensor 119 records information upon determining a change that has occurred with respect to storage compartment 108, such detecting when an object has been inserted or removed from storage compartment 108. In this embodiment, storage compartment sensor 119 may comprise a simple passive infra-red (PIR) device (i.e., a motion sensor).

Processor 300 may perform one or more actions after an event has been detected, as described above, i.e., that an object has been placed in or removed from storage compartment 108, a shock, vibration, or acceleration of the vehicle, a change in compass heading of the vehicle. For example, processor 300 may transmit certain information to one or more remote locations when an event is detected, such as to a vehicle owner, to a vehicle renter, delivery person, or other interested, authorized persons. Memory 302 may store contact information of one or more of these persons, and processor 300 may generate and transmit, via wide-area transceiver 306 an SMS, email or other electronic communication when an event occurs, comprising information such as an identification of the vehicle, a location of the vehicle (as determined by a vehicle location detector 316, such as a GPS, GLONASS, or other satellite-based detector, and/or wide area 306 when assisted GPS is used), a status of the vehicle (i.e., an indication as to whether the vehicle is moving or stationary as determined using SVACA sensor(s) 310, an indication as to whether the vehicle engine is on or not (as determined by processing audio information provided by microphone 312), a status of storage compartment 108 (i.e., object present or not present, a digital photograph, capacitance value, inductance value, etc.), an identification of a person who last opened cover plate 110 (as determined by a camera (not shown) mounted to plate 206 for photographing a user as a user operates smart license plate vault 100, or some other information.

SVAC sensor 310 comprises a shock, vibration, acceleration or compass orientation sensor(s) that provide physical information pertaining to the vehicle or the vehicle's surroundings. Smart license plate vault 100 may comprise all or a subset of each of these sensors, and further sensors are contemplated, such as a temperature sensor to detect an ambient temperature where the vehicle is located. A shock sensor can be used to detect events such as vehicle break ins, accidents, vehicle door entries and exits. A vibration sensor can detect whether the vehicle is moving or not or whether a vehicle engine is running or not. An accelerometer may be used to detect movement of the vehicle, or how fast a vehicle is being driven, based on the acceleration measured around turns or changes in street or highway topography. A digital compass may be used to determine a direction that the vehicle is pointed, or travelling. In any of the above examples, one or more thresholds may be stored in memory 302 so that when a measurement by any of the sensors exceeds, or falls below, one or more of the thresholds, processor 300 can take one or more predetermined actions, such as alert users near the vehicle by causing alert device 314 to activate and/or to transmit one or more alerts via wide area transceiver 306.

Microphone 312 comprises a small, inexpensive sound transducer that converts sound wave energy into electronic signals for processing by processor 300 in order to detect events that may occur in proximity to the vehicle and/or to smart license plate vault 100. For example, microphone 312 may be used to detect the vehicle's engine noise when the vehicle's engine is running, to detect a sound of a vehicle horn blowing, voice commands to smart license plate vault 100, code words to lock and unlock vault 106, etc. Microphone 312 typically comprises a piezo-type microphone.

Alert device 314 provides for alerting persons nearby smart license plate vault 100, for example that a vehicle break-in is occurring, to find a particular vehicle in an area where numerous vehicles are parked, such as in a vehicle leasing lot, a shopping mall parking lot, etc. Alert device 314 may comprise one or more lights, such as LEDs, positioned on or around smart license plate vault 100 and/or a speaker (not shown) for illuminating smart license plate vault 100, license plate 216 or sounding an alert. Alert device 314 is activated by processor 300 when processor 300 determines that certain events have occurred, such as when processor 300 determines that a shock, vibration, acceleration, change in compass heading, vehicle engine starting, etc. has occurred. Processor 300 may also cause alert device to activate when processor 300 receives a wireless command, either via local area transceiver 304 or wide are transceiver 306, to activate alert device 314. Such a command may be transmitted by a user via the user's personal communication device, i.e., smart phone, for finding the user's vehicle in a crowded parking lot, or in commercial applications in order to find a particular rental vehicle, or for a car dealer to find a particular make and model in a large dealer parking lot, to show to a customer.

Power port 120 is located on plate 206 and provides a connection to an external power source to provide power to certain components of smart license plate vault 100 when battery 114 is dead, such as to processor 300, memory 302, motor control circuitry and user interface 112. Battery 114 is located in depression 128 formed in plate 206, as shown in FIG. 1, having a tab 130 extending on one side (on the right side in this embodiment, as shown in FIG. 1) that, in one embodiment, interlocks with a catch 132 within plate 206 to secure battery 114 inside depression 128. In another embodiment, tab 130 comprises one or more through holes for mounting screws or bolts to pass into plate 206. In either case, when cover plate 110 is in the closed position, at least tab 130 is hidden behind cover plate 110, preventing battery 114 from being removed (in other embodiments, all or a portion of battery 114 itself may be covered by cover plate 110 when cover plate 110 is in a locked position in an embodiment where cover plate 110 is greater in width than what is shown in FIG. 1). If battery 114 does not have sufficient power to energize the components of smart license plate vault 100, battery 114 cannot be replaced unless and until vault 106 is opened. However, a user can connect an external power source to power port 120 and energize the components necessary to open vault 106 and, thereby, allow battery 114 to be replaced. In one embodiment, battery 114 is not charged when an external power source is connected to power port 120. This allows a smaller external battery to open vault 106, because the external power source does not have to use its charge to additionally bring the battery up to a certain charge level. In another embodiment, battery 114 is charged when an external power source is connected to power port 120.

Motor control circuitry 318 is used to control an electric motor inside or behind plate 206, to lock and unlock vault 106, i.e., moving mechanical locking mechanisms 126 or otherwise freeing cover plate 110 from storage compartment 108. Motor control circuitry is well-known in the art.

In one embodiment of using smart license plate vault 100, limited access to storage compartment 108 is provided to one or more authorized users, such as a package deliveryman, vehicle renter, vehicle repairman, etc. Access may be limited by time, location, or both. In this embodiment, a user may provide authorization for one or more other users by entering information to smart license plate vault 100 via user interface 112 or via an app on a computer, smart phone, etc. For example, an access code may be entered, followed by a time, or a time period, at which authorization expires. The access code may comprise an alpha-numeric sequence, a bar code, a QR code, an image, a code word, etc. The access code may then be provided to an authorized user. After the time is reached, or time period expires, the authorized user may no longer be able to access vault 106, even by using the access code provided by the user. Similarly, access may only be provided when processor 300 determines that the vehicle is within a boundary set by the user, as reported by location detector 316. In one embodiment, an access code is not used. In this embodiment, the user may set a time period during which the vault 106 is accessible without an access code, set a location where vault 106 is accessible without an access code, or both in a case where the vehicle may be in a safe location or otherwise when it is difficult or impossible to provide an access code to a second user.

In one embodiment, a user may set an access time or “time window” is defines as a time period in which a user may use an object secured inside vault 106. Such an application may find use in delivery services, where it is expected that a vehicle key would be used for only a short time in order to place a package or other delivery item into the vehicle. In this embodiment, a time window is defined, lasting anywhere from a minute to longer periods, such as a day or a week, using either user interface 112 or an app on the user's computer or smart phone. An access code is provided to an authorized third party, and when vault 106 is opened, processor 300 detects the opening of cover plate 110, and begins to track the elapsed time from when cover plate 110 was opened. In the case of a vehicle key, if the key is not returned to vault 106 by the time the time window expires (as determined by processor 300, for example, by causing storage compartment sensor 119 to take a reading of storage compartment 108 (i.e., a photographic, capacitive, inductive, ultrasonic or infra-red reading) when the time window expires, and determine, based on the reading, that the key has not been replaced), processor 300 causes wide area transceiver 306 to transmit an alert, indicating that the key was not returned to the vault within the time window. In another embodiment, when the time window expires, processor 300 may take a reading of storage compartment 108 and transmit the reading to the user and allow the user to interpret the reading to know if the key has been returned to vault 106 in time. In one embodiment, processor 300 may determine that the key was placed back inside storage compartment 108 within the time window. In this case, processor 300 may transmit a message to the user indicating that the key was replaced within the time window, so that the user knows that the task authorized by the user has been completed.

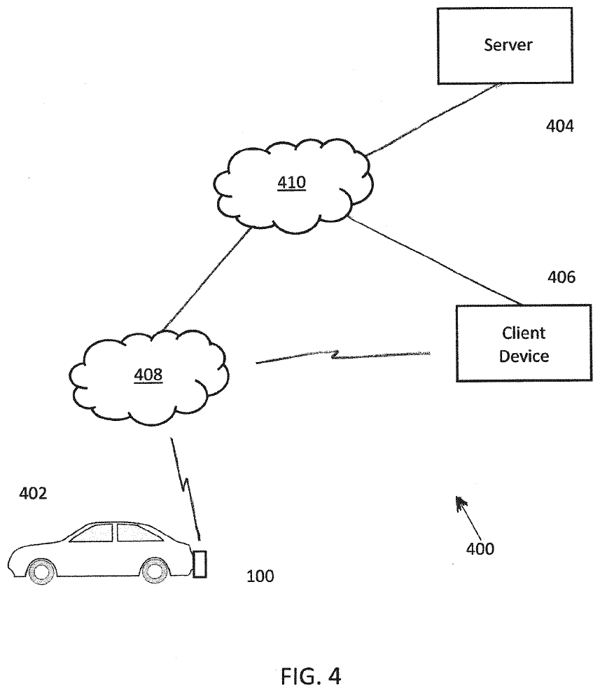

FIG. 4 is a block diagram showing one embodiment of a system 400 in which smart license plate vault 100 may be used. FIG. 4 shows a vehicle 402 comprising smart license plate vault 100, a server 404 and a client device 406. Smart license plate vault 100 is wirelessly coupled to cellular data network 408, which is in turn coupled to wide area network 410, such as the Internet. Server 404 and client device 406 are coupled via wide area network 410.

Smart license plate vault 100 may send alerts and other signals to client device 406 via server 404, where server 404 may process the alerts and signals from smart license plate vault 100 in order to determine certain events that may have occurred in proximity to, or to, vehicle 402, to determine the contents of storage compartment 108, to create and store historical information pertaining to vehicle 402 smart license plate vault 100 and/or and to contact one or more persons when certain events occur in proximity to, or to, vehicle 402.

An owner of vehicle 402 may install smart license plate vault 100 onto vehicle 402 and then create an account with server 404, providing such information as the owner's name, address, contact information, make and model of vehicle 402, identification information of smart license plate vault 100, billing information, etc. In response, server 402 creates an account associated with owner.

Server 404 may then receive alerts and other messages from smart license plate vault 100 and associate the alerts and messages to the owner's account, based on identification information sent by smart license plate vault 100 in each alert or message.

In one embodiment, server 404 may be used to determine an event that has occurred near, or to, vehicle 402 as server 404 receives certain information from smart license plate vault 100 after smart license plate vault 100 determines that an event may have occurred. Smart license plate vault 100 may send server 404 a message when one or more thresholds have been exceeded relating to a sound that occurred in proximity to vehicle 402, a shock, a vibration, an acceleration, or a compass heading experienced by vehicle 404, etc. When one or more thresholds have been exceeded, processor 300 causes wide area transceiver 306 to transmit a message with information pertaining to one or more of the conditions sensed by smart license plate vault 100. For example, smart license plate vault 100 may send a sound clip, a digital photograph or video, a shock, vibration, accelerometer, or a compass reading or series of readings, a voice command, etc. Server 404 processes such information to determine if the owner, or some other authorized persons, should be notified, in the case where server 404 determines that a predetermined event has occurred, such as a vehicle break-in, vehicle theft, accident, movement, non-movement, etc. based on the information provided by smart license plate vault 100 and based on rules that may be defined by the owner. For example, the owner may want to be notified by server 404 only when vehicle 402 experiences an acceleration greater than 30 feet-per-second squared and only between the hours of 10 pm until 5 am.

Server 404 may be configured to interpret words spoken by a user in proximity to smart license plate vault 100, or to evaluate access information provided by a user in proximity to smart license plate vault 100. For example, server 404 may be provisioned with word detection software that can determine when a code word is spoken by a user trying to access storage compartment 108. When server 404 determines that the proper code word has been spoken, server 404 provides a command to smart license plate vault 100 for smart license plate vault 100 to lock or unlock vault 106, as the case may be. Server 404 may evaluate other access information, such as a digital image of the user taken by the user's camera and provided to server 404 via an app on the user's client device, i.e., smart phone, a QR code, a bar code, a digital photograph of a portion of the user, such as a tattoo, retina, or other identifying indicia. In this case, server 404 compares the information to expected information stored in the server's database, previously provided by the owner of vehicle 402, to determine whether a match is found. If so, server 404 provides a command to smart license plate vault 100 for smart license plate vault 100 to lock or unlock vault 106.

Server 404 may further be configured to determine an object in storage compartment 108, using software specially configured to determine object types. Typically, such software utilizes a database of common objects small enough to fit within storage compartment 108. Upon receipt of a digital image or video from smart license plate vault 100, either upon the occurrence of a predetermined event occurring at or near the vehicle, or in response to a command provided by client device 402 to smart license plate vault 100, server 404 determines whether the digital image or video matches an object found in the database. If so, server 404 may then provide an alert to client device 406, indicating that a particular object is within storage compartment 108.

Server 404 may maintain a historical accounting of information pertaining to smart license plate vault 100, such as dates and times that vault 106 was opened and/or closed, event activity and associated times, dates and locations that each event occurred, messages sent to or received from smart license plate vault 100, etc. Such information may be provided to client device 402 upon request by the user.

Thus, various exemplary embodiments relate to a smart license plate vault that is attached to a vehicle and securely stores the vehicle keys for authorized retrieval. Individual users and vehicle fleet users can use the secure storage of the keys to permit authorized users to retrieve the keys and use the vehicle for intended purposes, such as driving of the vehicle and the providing of user requested services. The smart license plate vault also can include a number of sensors that can be used to monitor such things as the location, movement, and state of the attached vehicle and/or the operation and state of the smart license plate value itself. The location and movement information can be provided to a user to track movement of the vehicle and can be used to prompt a user to schedule services that may use the vehicle, such as maintenance and in-car delivery services.

The smart license plate vault can connect to a user device via a Bluetooth® or other wireless communication connection or to a remote server/system using a mobile network connection (e.g., cellular network connection), through which the user can access the smart license plate vault using a web-based portal. Through the application or web-based portal, the user can transmit commands to the smart license plate vault to unlock the secure storage compartment so that keys can be retrieved.

The ability to issue a command to access the vehicle keys stored in the smart license plate vault allows the user to grant other people access and/or use of the vehicle, such as service providers. The user can utilize the application or web-based portal to schedule vehicle services through an affiliated service provider. The service provider can gain access to the vehicle by retrieving the vehicle keys using the smart license plate vault. In this manner, the user can schedule services while they are not using the vehicle, such as when the user is at work. Other example services can include in-vehicle deliveries, with the smart license plate vault allowing the delivery person to retrieve the vehicle keys, unlock the vehicle to make the delivery and then relock and return the vehicle keys.

The smart license plate vault also includes a variety of sensors that can be used to determine a location, movement and other aspects regarding the motion of or imparted to the vehicle to which the smart license plate vault is affixed. This data can be used to assist in securing the vehicle from unwanted or unauthorized usage. A location sensor can receive satellite information to assist with determining the location of the vehicle and that location can be transmitted to a user device and/or remote server/system to allow the vehicle to be tracked. The tracking of the vehicle may be configurable by the user and/or the service provider, such as to prolong the battery life of the smart license plate vault. An included Bluetooth® beacon can also assist with locating the vehicle when the signal from the Bluetooth® beacon is received at a nearby user device or reader.

The motion sensors of the license plate vault can sense motion of the attached vehicle. This detected motion can be used to trigger various events or processes, such as collision notification, trigger location tracking transmissions, transmission of a tampering notification and/or other events or processes. Movement of the vehicle can be used to determine the interval at which location tracking information is transmitted by the smart license plate vault. Additionally, monitoring the motion sensor data can provide indications that the attached vehicle was in a collision or that there is attempted tampering with the vehicle or smart license plate vault and an appropriate alert or notification can be used.

The smart license plate vault can assist users with managing a fleet of vehicles. Rather than having the fleet vehicle keys stored in a central location, the keys can be stored with the individual vehicle making tracking and retrieving vehicle keys easier. Additionally, the access can be logged and recorded to assist with minimizing misuse of fleet resources. Further, data regarding vehicle usage can be recorded and analyzed to assist with making decisions regarding the vehicle fleet.

With reference again to FIG. 1, which illustrates the smart license plate vault 100 that attaches to a vehicle's license plate mounting locations or bracket and contains a secure storage compartment 108 that can be accessed by the user upon command, the smart license plate vault can be securely attached to the vehicle, such as by the use of screws or other fasteners that can be covered or otherwise prevented from being tampered with. The user can access the secure storage compartment 108 such as, without limitation, through a service provider application on a user device, through a web-based portal provided by the service provider, or through a user interface 112 such as a keypad, e.g., by providing a pin code using the user interface 112. In some embodiments, the user device can communicate with the smart license plate vault 100 such as by using a Bluetooth® connection or other wireless communication connection, e.g., Bluetooth LE, near-field communication (NFC), or even visible light communication (VLC) if the smart license plate vault includes a camera or other light sensor that can be used to sense and decode visible light communication signals transmitted using the camera LED or other light emitter of the user device, and can transmit a command to the smart license plate vault 100 to grant the user access to the secure storage compartment 108. Additionally or alternatively, the command to provide access can be issued by a remote server or system provided by the service provider. The user can access the web-based portal to verify their authorization to interact with the smart license plate vault 100 and can cause the remote system to transmit the command to the smart license plate vault 100 over a mobile network connection. Alternatively, the user can provide a pre-determined or time-based pin code through the user interface 112 to gain access to the secure storage compartment 108. It should be noted that embodiments are not limited to any particular type of user interface and can include such things as a camera (e.g., to provide access using visible light communications, facial recognition, reading a code such as a barcode or QR code from the user device, etc.), a fingerprint reader (e.g., to provide access using a fingerprint scan that could be authenticated by a remote server or system provided by the service provider), a microphone, a retina scanner, or other user interface. In some embodiments, the user device can act as a user interface for the smart license plate vault such as by providing a user interface through which the user can enter a code (e.g., perhaps in lieu of entering the code directly through a user interface of the smart license plate vault), employing the user device camera for facial or other scanning, employing the user device fingerprint scanner for fingerprint scanning, sending a “challenge” to the user device such as through text messaging (e.g., access to the vault could be provided upon the user successfully responding to the challenge such as by clicking on a link or responding with a designated reply), or utilizing other capabilities of the user device. User authentication actions taken through the user device can be communicated to the smart license plate vault and/or to a remote authentication system. Interaction with the smart license plate vault such as someone entering a code or otherwise attempting to access the vault could be treated as a form of login attempt that the system could authenticate such as using two-factor authentication or other authentication mechanism, e.g., by sending a message to the user device to confirm that the user or a person authorized by the user is accessing the vault. In some cases, third party authentication systems (e.g., cloud-based authentication systems) could be leveraged to help authenticate the user, e.g., an app running on the user device could leverage fingerprint or other user authentication provided by the user device to authenticate the user.

Vehicle keys or other items can be stored securely in the storage compartment 108. Among other things, this can allow the user to lock their keys up while they partake in an activity so that the vehicle keys do not become misplaced. Similarly, users can permit others to access the secure storage compartment 108 of the smart license plate vault 100 so that various services or usages of the vehicle can be performed, such as performing vehicle maintenance or allow another person to use the vehicle. For example, a car sharing or rental service can store vehicle keys in a smart license plate vault 100 attached to a vehicle. The renter can then input a pin code using the user interface 112 or otherwise provide authorization (e.g., through an installed application or by contacting a remote operator) to then access the vehicle keys from the storage compartment 108.

The storage compartment 108 can be arranged and constructed in a manner so as to prevent or inhibit attempts to access the storage compartment 108 in an unauthorized manner. For example, a cover plate 110 can be tightly fitted and recessed so as to prevent insertion of a prying tool that could be used to open the cover plate 110 to access the storage compartment 108. Similarly, environmental intrusion can be limited or prevented by the arrangement and/or construction of the storage compartment 108. Guttering can be positioned about the storage compartment 108 to direct water and moisture about the storage compartment 108 so that it does not intrude into the storage compartment 108 and potentially damage the contents therein. The smart license plate vault 100 as a whole can include various structural features and constructions to limit and prevent environmental intrusion, such as preventing the accumulation of road grime within the smart license plate vault 100 by including vents that direct airflow through the smart license plate vault 100 structure to prevent such accumulation.

Further, the storage compartment 108 can include features to assist with maintaining the security of vehicle keys stored therein. More and more vehicles include remote unlock and lock functionality on the vehicle keys and many also allow a vehicle to be started and driven as long as the keys are within the vehicle. Currently, there are techniques that can be used to capture the radio frequency signals used by the keys to communicate with the vehicle. These signals can then be spoofed to trick the vehicle into thinking the keys are present, allowing the car to be unlocked or stolen without the physical damage that was common with previous auto theft techniques. To prevent the acquisition of the radio frequency signals from the keys stored within the storage compartment 108, the storage compartment can include signal-blocking features, such as a Faraday cage.

In some embodiments, a user may store a vehicle key within the smart license plate vault while using another key to drive the vehicle. In this manner, the stored key can be used such as when the user misplaces or loses the other vehicle key, when the user lends the vehicle to another person, or by a service provider who needs access to the vehicle. However, this stored key will be subject to the vibrations and movement caused by motion of the vehicle, and this could potentially damage the stored vehicle key. The storage compartment 108 therefore can include anti-rattling features to prevent such damage, such as padding or a secure, tight-fitting storage pocket or other restraint (e.g., hook-and-loop strap, mechanical clasp, etc.) that restrains the vehicle key from movement within the storage compartment 108.

The storage compartment 108 can also include features to assist with detecting the presence of a vehicle key within the storage compartment 108. This can be useful for monitoring and determining that the vehicle key has been returned after an authorized party has completed their use of the vehicle and/or to confirm that the vehicle key is present prior to a user reaching the vehicle and expecting to be able to use the vehicle. In an example, the storage compartment 108 can include a digital camera that can image the interior of the storage compartment 108. The interior can be imaged upon return of the vehicle keys, on demand, at intervals or in another arranged or scheduled manner, to assist with determining if the vehicle keys have been returned or are present within the storage compartment 108. The captured image can be transmitted to a remote server/system of the service provider for storage and automated image analysis to determine if the vehicle keys are present. Alternatively, the captured image can be transmitted to a user's device where they can view the image and confirm the presence or lack of vehicle keys in the storage compartment 108. Similar manual confirmation based on viewing of the image can also be performed by an operator, such as may be provided by the service provider or an entity that manages and oversees multiple smart license plate vaults (e.g., car dealership/vehicle fleet management). In another example, the storage compartment 108 can include a Near-Field Communications (NFC) reader and the user can place an NFC sticker on the vehicle key or key holder. When the keys are in the storage compartment 108, the NFC reader can verify the presence of the key by reading the NFC sticker on the vehicle keys. The smart license plate vault can then transmit a notification indicating whether or not the vehicle keys are present within the storage compartment 108. For vehicles with “smart” car keys, the vault may simply have a sensor that can detect the presence of the key using the existing signaling of the key (e.g., akin to the vehicle's systems for detecting the key) such that no NFC sticker would need to be placed on the key or key holder. Again, the smart license plate vault can then transmit a notification indicating whether or not the vehicle keys are present within the storage compartment 108. Other key detection mechanisms may be used, and embodiments are not limited to any particular type of key detection mechanism.

The smart license plate vault 100 can include multiple sensors for sensing various aspects of the smart license plate vault 100 and/or the surrounding environment about the smart license plate vault 100. For example, a location sensor (e.g., GPS, other navigational system sensors, or combination thereof) can be used to obtain information regarding the current location of the smart license plate vault 100 and the vehicle to which it is attached. This location information can be transmitted to a remote location, such as to a user device or a remote server/system of the service provider. The location data can also be stored locally and retrieved from the smart license plate vault 100, such as by connecting the smart license plate vault 100 to a computer or other device via a wired or wireless connection. The smart license plate vault can also include motion sensors (e.g., inertial sensors such as accelerometers or gyroscopes) that detect movement of the vehicle and potential impacts to the vehicle. Again, such information can be transmitted from the smart license plate vault and/or stored locally. The motion sensors, location sensor and/or other inertial sensors can be grouped as an inertial motion unit (IMU) that detects and provides data regarding the movement by or imparted to the vehicle. Other sensors can also be included in the smart license plate vault 100 to support functions and features of the smart license plate vault 100, such as sensors that assist with detecting tampering of the smart license plate vault 100.

As previously discussed, the smart license plate vault 100 can communicate with external devices or systems such as using a wireless communication connection (e.g., a Bluetooth® connection), a mobile network connection (e.g., cellular network connection), or other communications connection. A wireless communication connection can be established between the smart license plate vault 100 and a user device to allow the user to issue commands to the smart license plate vault 100 using an application installed on the user device. Similarly, the mobile network connection can be used to provide commands to the smart license plate vault 100 and can also be used by the smart license plate vault 100 to transmit information to an external or remote server or system, such as maintained/provided by the service provider or other trusted entity. These wireless connections generally require an antenna to receive and send communications. However, the metal of the license plate and the vehicle to which the smart license plate vault is attached can interfere with the reception and transmission of signals by the smart license plate vault 100. Therefore, the antenna(s) of the smart license plate vault 100 generally would be positioned so as to minimize or reduce such interference. This reduction of interference generally also would reduce the power required to transmit signals from the smart license plate vault, helping to preserve battery life.

The software of the smart license plate vault 100 can be updated using one of the described connections. The mobile network connection can allow “over the air” updates to be issued by the service provider to selected ones or all of the smart license plate vaults in use. Similarly, data stored on the smart license plate vault 100 can be retrieved using one of the described connections, such as stored location and access data. Alternatively, or additionally, an external data connection can be included on the smart license plate vault 100 to allow updates to be provided to and data to be retrieved from the smart license plate vault 100. Access to such a data connection can be secured, such as by placing the connection in the storage compartment 108, to prevent unauthorized use of such a connection.

The smart license plate vault 100 includes the battery 114 that provides electrical power for the various functions and features of the license plate vault 100. The battery 114 is rechargeable and can be recharged or replaced as needed to ensure that the smart license plate vault 100 has sufficient electrical power to support its functions and features. The battery 114 can be securely restrained within the smart license plate vault 100 to minimize potential tampering with the battery, such as might be performed by an unauthorized user attempting to access the storage compartment 108.

A user may be able to interact with the smart license plate storage vault through a service provider application on a user device or through a web-based portal that is provided by the service provider or other trusted entity, which are discussed in further detail below. The user can be required to verify their identity prior to being able to access one more smart license plate vaults with which they are associated. When successfully logged in, the user can be presented information regarding the one or more smart license plate vaults, such as status or location information. For example, the user can be presented with just the one smart license plate vault they are connected to locally through a Bluetooth® connection or can be presented with multiple smart license plate vaults when using the web-based portal. When presented with multiple smart license plate vaults, they can be arranged in an order, such as those that are closest to a current location of the user, or based on other criteria, such as which smart license plate vault is currently being attempted to access (e.g., which one has the cover plate lifted or moved). The user can select and interact with a smart license plate vault, such as to issue commands or to view status information regarding the vault. Through the application or web-based portal, the user can command the unlocking of the storage compartment to access the vehicle keys. Additionally, the user can view the status information, such as the current location of the attached vehicle, locating history information, battery status information and other information regarding the selected smart license plate storage vault.

Additionally, while viewing a selected smart license plate storage vault, the user can be presented with various available services that can be requested. For example, the user can schedule maintenance or refueling services through an affiliated service provider within the application or web-based portal. When the service provider arrives at the vehicle to provide the requested service, the user can be notified and can provide a command to unlock the storage compartment to allow the service provider to retrieve the vehicle keys. Alternatively, the service provider may be able to use their own user device to access the storage compartment and the user can grant such permission as part of scheduling the service. In a further alternative, the user can provide the service provider with a one-time or time-expiring pin code that the service provider can use to access the storage compartment to retrieve and replace the vehicle keys. In an embodiment, a dispatch center or operator of the service provider can provide service provider representatives with access to the storage compartment of the user's smart license plate vault, such as by providing a temporary pin code or transmitting a command directly to the smart license plate vault. All such access granted by the user to a service provider can be temporary and the duration during which such access is valid can be set by the user or predetermined as part of the service offering process.

To further assist in securing access to the smart license plate storage vault, the service provider may monitor the access and/or access requests/commands for potential unauthorized activity, such as hacking. The service provider can then restrict access to the smart license plate storage vault until further identity verification measures are completed to confirm the authenticity of the requests/commands.

Access to Storage Compartment

In certain embodiments, the smart license plate vault communicates via a Bluetooth® connection and a mobile network connection. The Bluetooth® connection is used to communicate locally about the smart license plate vault and the mobile network connection allows for communications with remote systems and devices. These connections can be used to grant access to the secure storage compartment of the smart license plate vault and/or receive information regarding the smart license plate vault. Information regarding the smart license plate vault can include data regarding the location or status of the smart license plate vault.

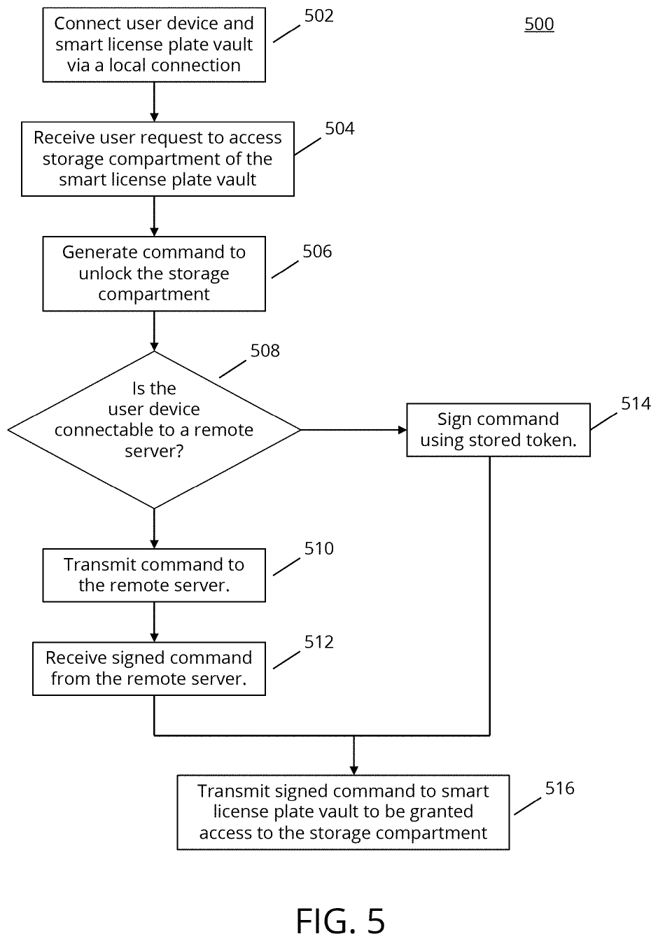

The smart license plate vault can be paired with a user device to allow the user to access the smart license plate vault through an application on the user device, such as shown in the method 500 of FIG. 5. At 502, the user device and smart license plate vault are connected via a local connection, such as a Bluetooth® connection. If the connection is a new Bluetooth® connection, the user device and smart license plate vault can be paired using a public key exchange and communication from the user device to the smart license plate vault uses asymmetric cryptography to secure the communications. At 504, when the user wishes to access the storage compartment of a connected smart license plate vault, the user can interact with the installed application on the user device to request that the smart license plate vault be unlocked. The user can be first verified, such as by using a verification process that secures a user device (e.g., pin code, facial recognition, etc.) to verify that the user is authorized to access the smart license plate vault via the installed application on the user device.

In response to the request, the application issues a command to unlock the storage compartment at 506. At 508, it is determined whether or not the user device is in communication with a remote server, such as an authorization server under the control of the service provider or other trusted entity. If the user device is capable of connecting to the remote server, the command from the application first transmitted to the remote server at 510, where it is signed at 512 to confirm the authenticity of the command. This prevents fraudulent commands from being issued and used to access the storage compartment, further securing the storage compartment from potential intrusions. When the determination at 508 determines that the user device is not or is unable to connect to the remote server, the user device can instead sign the command at 514 using a stored token. The tokens are generated and signed by the remote server and a predetermined number can be stored on the user device for use when the user device is unable to connect to the remote server. This prevents the user from being unable to access the storage compartment when the remote server cannot be accessed by the user device. At 516, the signed command is transmitted to the smart license plate storage vault. When the command from the user device is received, the smart license plate vault validates the signature to confirm the command is authentic before granting access to the storage compartment, such as by unlocking the storage compartment.

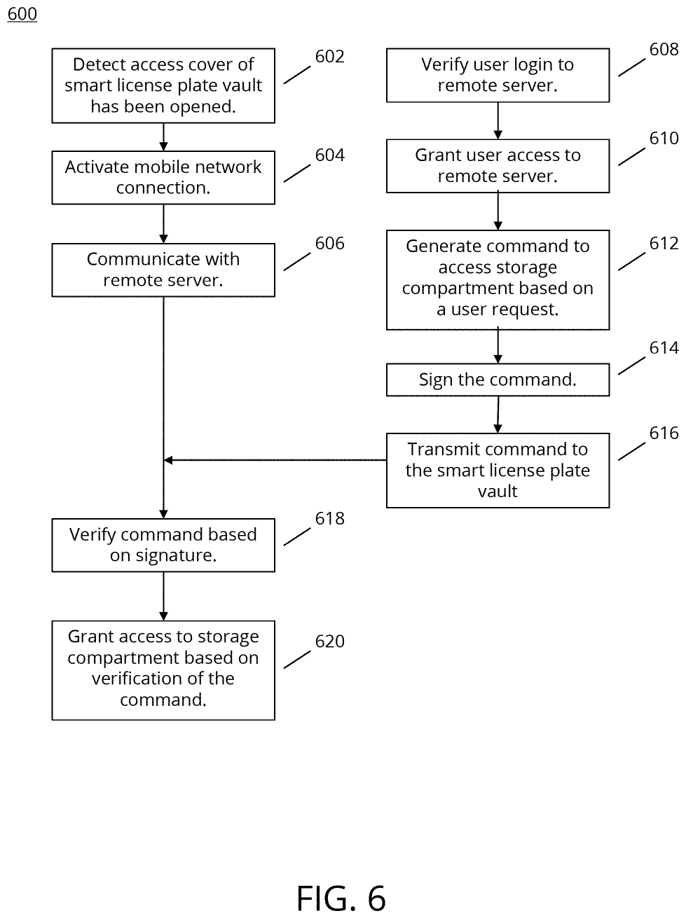

Access to the storage compartment can also be granted using the mobile network connection. This allows the user to request or another person to grant access to the storage compartment. To preserve battery resources, the mobile connection can be activated as needed. In an example method 600 of FIG. 6, of granting remote access to the storage compartment via the mobile network connection, the mobile network connection can be maintained in a primed or sleep state and when it is detected at 602 that an access cover (e.g., movable portion 104 of FIG. 1) of the smart license plate vault is opened the connection can be activated at 604. When connected to the mobile network, the smart license plate vault can communicate with a remote server at 606 and authorized users can issue commands to the smart license plate vault through the server, such as to unlock the storage compartment.

Authorized users can go through a sign-in process at 608 to be granted access at 610 to the smart license plate through the remote server, which can be maintained and supported by the service provider or other trusted entity. In this manner, a number of users can be authorized to provide access to the storage compartment of a smart license plate vault and can do so remotely. For example, a user can have access to the remote server via an Internet connection of their user device. The user can log into the remote server using a website or the application as described above and can then issue commands at 612 to the smart license plate vault to access the storage compartment. The user can be presented with the smart license plate vault for which the access attempt has been detected to allow the user to direct the command to that particular smart license plate vault. In another embodiment, the user can be presented with a listing of multiple license plate vaults for which the user is authorized to interact with. Optionally, the listing can include the location of these smart license plate vaults. The user can then select a smart license plate vault to which the command is to be directed to.

At 614, the server can similarly sign the command, as described above, and then transmit the command to the smart license plate vault at 616 via the mobile network connection. Upon receiving the command, the smart license plate vault can verify the authenticity of the command and then allow access to the storage compartment, such as by unlocking the storage compartment.

Another means of accessing the storage compartment is through the use of a pin code that a user can input via a keypad (e.g., user interface 112 of FIG. 1). The pin code can be predetermined or time-based. With the predetermined pin code, the manufacturer can preprogram the smart license plate vault with a pin code that is then provided to the user or the user can select a pin code and program that pin code into the smart license plate vault. The user can later input the predetermined pin code on the keypad to access the storage compartment. Alternatively, the pin code can be time-based, with a hash function being used to generate a pin code that is only valid for a predetermined amount of time. The user can use an authenticator application (such as the Google Authenticator App) to scan, enter or receive the hash code and the authenticator application can provide the user with a currently valid pin code. The pin code is continuously updated and changed at the predetermined time interval based on the hash function.

A further potential means of access can be using Near-Field Communications (NFC) between the smart license plate vault and a user device. Rather than communicating via a Bluetooth® connection, the user device and smart license plate vault can communicate through an NFC connection to allow the user device to transmit secure commands to the smart license plate vault, such as to allow the user to access the storage compartment.

Yet another potential means of access to the storage compartment of the smart license plate vault can be through the use of voice recognition. The smart license plate vault can include a microphone that can receive utterances made by the user. A processing unit of the smart license plate vault can process the utterance to recognize the word(s) spoken by the user and/or individual characteristics of the voice of the speaker. That is, the words spoken by the user can be parsed and identified and matched to a predetermined pass phrase to determine whether or not they match and the smart license plate vault should grant access to the user. Alternatively, or additionally, the spoken words can be analyzed to match user-specific voice characteristics to a set of stored voice characteristics to determine if they match and the user should be granted access. In another embodiment, the user spoken utterance can be recorded and transmitted to a remote server or system for processing/analysis and the remote server or system can then transmit a command to the smart license plate vault to grant the user access when it is determined that a voice match or recognition has been successful. Similarly, the user can speak the utterance into their user device which can perform the necessary validation process and then transmit a command to the smart license plate vault to grant the user access.

Tracking and Security

The smart license plate vault includes a number of sensors, such as a location sensor and motion sensors. These sensors can be used to allow a vehicle, to which the smart license plate vault is affixed, to be tracked and monitored for various purposes, such as for vehicle security.

A location sensor, such as a Global Positioning Sensor (GPS) or other navigational sensor, can be used to determine the current location of the vehicle to which the smart license plate vault is attached. The mobile network connection can be used to transmit this location information to a remote system, where it can be viewed, shared, processed and/or stored. The remote system can be maintained and supported by the service provider or another entity and smart license plate vault users can be granted secure access to view the location information regarding one or more smart license plate vaults with which the user is associated. Secure access to the location information may be desirable so as to prevent access by non-authorized parties to such private or personal information.

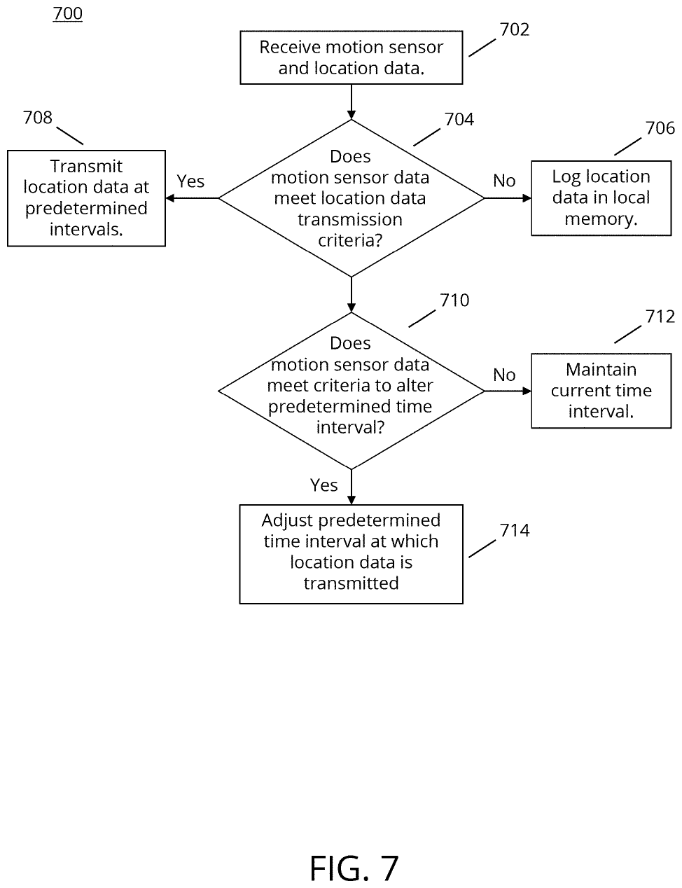

Since transmitting data over the mobile network connection can consume significant amounts of power, the transmission of the location data can be scheduled or structured so as to limit such transmissions. That is, rather than continuously transmitting a location of the smart license plate vault, the location can be transmitted at intervals that may be predetermined, triggered by events, or a combination thereof. For example, an algorithm can be used to adjust the location transmission rate, such as illustrated by method 700 of FIG. 7. At 702, motion sensor and location data can be received, such as at a processing unit of the smart license plate vault. At 704, it can be determined whether or not the received motion sensor data meets predetermined criteria to cause the location data to be transmitted. If the motion sensor data does not meet the criteria, the location data can be optionally logged or stored at 706 and can be transmitted or retrieved at a later time. If the motion sensor data does meet the criteria, the location data can be transmitted at 708 at a predetermined interval to a remote system, such as described above. It can then be determined at 710 whether or not the motion sensor data meets criteria to cause the predetermined location information transmission interval to be altered. If the motion sensor data does not meet such criteria, the predetermined interval at which the location data is transmitted remains the same at 712. If the motion sensor data does meet the criteria, then the predetermined interval at which the location data is transmitted can be altered at 714, such as shortening or lengthening the timing between the transmissions of location data. In this manner, the rate at which location data is transmitted by the smart license plate vault is adaptive based on the motion sensor data. The criteria and corresponding predetermined intervals of location data transmission can be updated or revised as necessary, such as to improve the location information capture and/or to reduce the power consumption of the location data transmission process. Additionally, the smart license plate vault could be allowed to select or be programmed to use certain criteria based on other data, such as a power state of the battery. For example, when the power state of the battery is low, the smart license plate vault could select criteria and associated predetermined intervals that reduce the rate of location information transmission to prolong the useful battery life.

In an embodiment, an algorithm can be used to determine the rate or when the location information of the vehicle license plate vault is transmitted to a remote system, such as an inertial measurement unit (IMU) algorithm. The IMU-based algorithm can receive various sensor data regarding motion of the vehicle and this sensor data can be processed to determine a motion state of the vehicle on which the location information transmissions can be based. For example, the algorithm can be speed dependent and can trigger the location information to be transmitted when the vehicle is in motion, as determined by the motion and/or location sensors. The adaptive nature of the algorithm can cause the rate of the location information transmissions to be increased as the speed of the vehicle increases, again as determined from the motion and/or location sensor data. Since the vehicle will be travelling farther distances between intervals as the speed increases, it may be desirable to commensurately decrease the duration of the intervals so that a fidelity of the location information can be maintained. In another example, the algorithm can use motion of the vehicle to trigger the location information transmission, such as transmitting the location data when it is determined the vehicle has stopped moving, such as in response to a traffic control device or when the vehicle has reached a destination. Using vehicle stops to trigger the location information transmission may not provide as much detail regarding a specific path of travel the vehicle took, but can assist in minimizing or reducing the power consumed to provide the location information since the time between vehicles stops is likely to be less longer than predetermined, time-based intervals, thereby reducing the rate at which the location information is transmitted.

The rate at which the location information is transmitted and the various criteria that determine and/or trigger the transmissions can be predetermined by the service provider and/or allowed to be user selectable. In an example, the service provider can preprogram the smart license plate vault with one or more algorithms or routines that are used to determine triggers and timing of the transmission of location information by the smart license plate vault. The algorithm(s) can be locked or secured to prevent the user from altering aspects of the algorithm, such as the event triggers, predetermined time intervals, and other aspects of the algorithm that are used to cause the location information to be transmitted. These algorithms can be optionally updated through software updates that the service provider provides to the smart license plate vault. Alternatively, the user can be allowed to manage the algorithm, such as selecting specific event triggers, setting the duration of time intervals between transmissions and/or other aspects of the location information transmission. In this manner, a user or organization associated with one or more smart license plate vaults can specify the manner in which the location information is transmitted by the smart license plate vault. This allows users who want more real-time or higher fidelity tracking of a vehicle to do so or allows user to modify or adjust the tracking as needed or desired, such as to prolong battery life.

The location information can also be used to provide or advertise services to the user, as discussed further below. As with many location tracking services, privacy is a concern. Users are provided the opportunity to opt out of location information transmission services. However, opting out of such services can reduce the effectiveness and ability of the security functions and features of the smart license plate vault.

In addition to the Bluetooth® connection that is used to communicate locally with a user device, the smart license plate vault can also include an ultra wideband (UWB) Bluetooth® beacon. The UWB Bluetooth® beacon draws minimal power, as discussed below, and can provide locating of the smart license plate vault and the attached vehicle. In most cases, a vehicle is likely to be parked outdoors where it can receive GPS location signals and transmit location information to a remote server or user device via the mobile network connection. However, in some instances the smart license plate vault may be prevented from doing so, such as when the vehicle is located within a parking garage. The UWB Bluetooth® beacon can broadcast a signal that allows a user device to locate the vehicle in such situations. The user can walk through the parking garage and the application on the user device can process the UWB Bluetooth® beacon signal to guide the user towards the vehicle, such as by displaying an arrow pointing in the direction of the origin of the UWB Bluetooth® beacon signal or other suitable means of conveying such information to the user. The UWB Bluetooth® beacon locating ability can also help users locate vehicles in crowded locations, such as in parking lots. This can be useful when loaner vehicles are parked in a garage or lot. The user can be provided a link or file that includes information relating to the UWB Bluetooth® beacon of the smart license plate vault affixed vehicle that the user is renting. The user device can process the link or file and begin providing directions towards the vehicle based on the UWB Bluetooth® beacon signal being emitted by the attached smart license plate vault. Similarly, this functionality can assist service providers with locating the vehicle in a parking lot or garage more effectively and efficiently than observing and comparing the parked cars to a provided description.

In addition to being used to provide location information, the sensors of the smart license plate vault can also be used to assist with securing and protecting the vehicle, such as from unwanted use and/or to provide notification of damage to the vehicle.

In an example, the location information can be used to monitor movement of a vehicle that has the smart license plate vault attached to determine if the vehicle exceeds a predetermined area. This can be useful in vehicle fleets, such as rental cars or service vehicles, to monitor if the vehicles are being used in areas that are prohibited or out of the normal usage pattern. Using the application on a user device or by interacting with the remote server, such as through a webpage, the user can provide a geofenced boundary area. If the vehicle moves outside of the geofenced area, an alert can be transmitted to the user to inform them that such movement has occurred. Using the application or webpage, the user may be able to view a map of a specified area and can then draw or indicate on the map the extents of the geofenced area. The location of the vehicle can then be monitored at a remote server or system using location information provided by the smart license plate vault. When it is determined the vehicle has exceeded the geofenced boundary, the remote server can transmit an alert to the user, such as in the form of a pop-up notification on the user device, an email, as a text message or other form of notification. Alternatively, or additionally, the geofenced boundary can be transmitted to the smart license plate vault, which can then use its acquired location information to monitor and determine if the smart license plate vault and attached vehicle move beyond the geofenced boundary. In response to determining that the smart license plate vault has moved beyond the boundary, the smart license plate vault can transmit a notification or alert to the remote server and/or the user via the mobile network connection.

The smart license plate vault also includes motion sensors, such as accelerometers and gyrometers, that can be used to monitor for collisions between the vehicle, to which the smart license plate vault is attached, and another object or vehicle. A crash detection algorithm can monitor motion sensor data to determine if such a collision has occurred, such as by determining if accelerometer data exceeds a predetermined threshold indicative of a collision. In an example, there may be multiple predetermined thresholds that are used and can indicate a potential severity of the collision. Further, the predetermined thresholds can also be dependent on the vehicle speed, to further assist with determining a collision occurred and the severity of such a collision.

In response to a collision, the smart license plate vault can transmit a notification directly to emergency services or to the remote server where an operator can be alerted to contact emergency services on behalf of the vehicle and its occupants. The notification can include current location information and a severity of the collision so that an appropriate emergency response can be dispatched. In the example of directly contacting the emergency services, the smart license plate vault can use a predetermined text or other message template that is then completed with the requisite vehicle location information before being transmitted to the emergency services. In the example of transmitting the notification to the remote server, an operator can receive or view the notification on the remote server and can then contact emergency service, such as by placing a phone call to the local emergency services of the location of the vehicle collision. The contact information of the local emergency services could be provided automatically to the operator based on the collision location information included in the notification.

In some cases, the vehicle may be stationary and is hit by another object or vehicle, such as during an act of vandalism or a hit-and-run accident. The motion sensors of the smart vehicle license plate can detect such a collision and log various pertinent information, such as the location and time of the collision, which can then be transmitted as an alert to the user and/or the remote server. Providing such detailed information can assist law enforcement authorities in an investigation of the collision and to determine who or what vehicle may have been responsible. Further, the smart license plate vault could issue an audible alert in response to detecting such a collision to draw attention to the incident as a deterrent or to assist with having bystanders witness the incident to be able to provide information to the relevant authorities.

Similarly, the sensors of the smart license plate vault can assist with deterring and or detecting incidents of vehicle theft. While the vehicle is parked, the smart license plate sensors can continue to monitor various aspects of the vehicle and the surrounding environment for potential indications of vehicle theft or tampering. Additionally, the sensors of the smart license plate vault can monitor for potential tampering or forced entry into the smart license plate vault. Accelerometers or gyrometers can be used to sense motion, such as could be caused by a person trying to access the vehicle using force or unauthorized entry techniques, or indicating that a person is tampering with the smart vehicle license plate. For example, a person trying to steal the keys from the storage compartment may attempt to simply remove the smart license plate vault from the vehicle or attempt to force entry into the storage compartment. The sensors of the smart license plate vault could detect such tampering attempts and provide a notification and/or audible alert that such tampering is occurring.

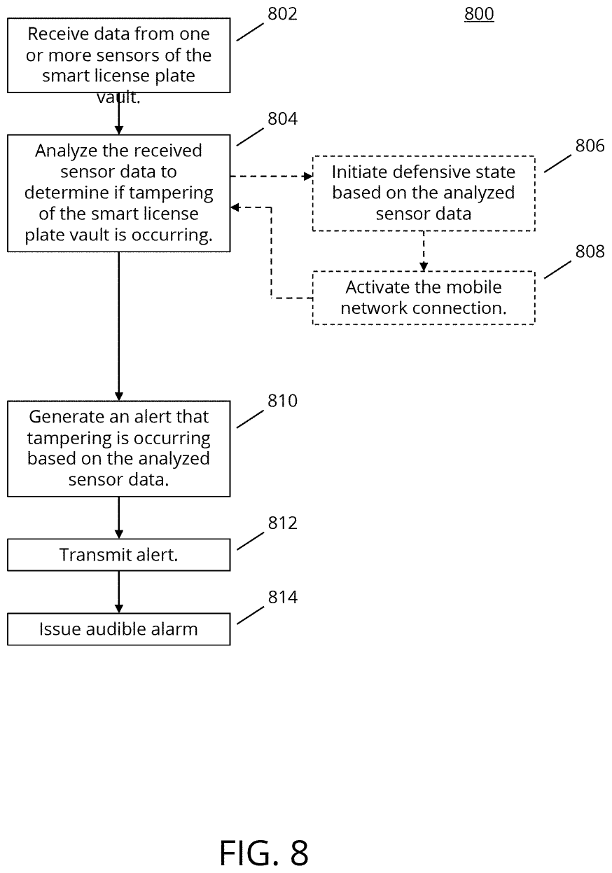

The method 800 of FIG. 8 illustrates an example intrusion detection and alert method. At 802, data from one or more sensors of the smart vehicle license plate is received, such as accelerometer data, motion sensor data, thermal sensor data and/or other sensor data. At 804, the data is analyzed to determine if a potential intrusion or tampering of the smart license plate vault is occurring. For example, accelerometer and/or motion sensor data could indicate that someone is trying to remove or tamper with the smart license plate vault. In another example, thermal sensor data could indicate that someone is attempting to access or tamper with the smart license plate vault using a method that generates heat, such as a torch or grinder being used to open the storage compartment. At 812, an alert can be generated to indicate that tampering with the smart license plate vault is occurring based on the analysis of the sensor data, such as the sensor data exceeding a predetermined threshold value or other evaluation criteria.

Optionally, the analysis of the sensor data may be inconclusive that a tempering attempt is occurring. However, the analysis of the sensor data at 804 could cause the smart license plate vault to initiate a defensive state at 806, such as when the sensor data does not meet the threshold of a tampering attempt but exceeds a baseline threshold or deviates beyond an allowable amount from previous sensor data. At 808, as part of the defensive state, the mobile network connection of the smart license plate vault can be activated. This prevents a delay in sending information that might otherwise be caused by waiting for the mobile network connection to be activated before sending a tampering alert or notification. In response to initiating the defensive state, the smart license plate can transmit an indication that it is in the defensive state to a remote server or system of the service provider using the activated mobile network connection. The remote server/system can then periodically check to see if the smart license plate vault exits the defensive state. It is expected that after a predetermined amount of time without detecting a tampering attempt, that the smart license plate vault will exit the defensive state and transmit an indication to the remote server/system that such a state has ended. If the remote server/system does not receive such an indication it can send an alert to a user or other that contact with the smart license plate vault has been lost due to suspected tampering.

Additionally, in the defensive state, the analysis at 810 of the received sensor data can be modified or adjusted. For example, the thresholds, criteria and/or allowable deviations can be adjusted to be lower, reduced and/or narrowed, putting the smart license plate vault in a heightened state of security. Further, a rate at which the sensor data is received and analyzed can be increased to assist with monitoring for potential tampering. Since the increased rate of data acquisition and analysis consumes further power reserves, it may be desirable to limit the period of time during which the smart license plate vault remains in the defensive state. In the defensive state, sensor data continues to be received and analyzed in the defensive state and an alert can be generated at 812 when such analysis indicates that tampering is occurring.

At 814, the alert is transmitted, such as to a remote server or system, a user device or other location and/or designated user(s). The transmitted alert notifies the recipient that potential tampering is occurring so that they may take actions they determine necessary, such as notifying law enforcement. Optionally, the smart license plate vault can also issue an audible alarm at 816 to draw attention to the detected tampering and also provide a potential deterrent.

In another example embodiment, data from potential tampering and intrusion attempts can be stored and analyzed to further refine the algorithm used to detect such incidents. Machine learning, artificial intelligence or other neural computing techniques could be used to analyze the data and determine correlations or indicators that can be used to further refine the algorithm or processes that evaluate the sensor data to determine if tampering is occurring.

In some embodiments, multiple smart license plate vaults and the attached vehicles may be commonly collocated, such as at an auto dealership or vehicle rental lot. If one of the collocated smart license plate vaults detects tampering, it can broadcast a signal, such as via the Bluetooth® connection, to the other nearby smart license plate vaults to cause them to enter a defensive state. This primes the other smart license plate vaults to be able to quickly alert to similar tampering, should such efforts be made. Alternatively, or additionally, the collocated smart license plate vaults can establish a local mesh network each other via the Bluetooth® connection or another type of communication connection. Similarly, when one smart license plate vault in the mesh network detects tampering it may alert the other connected smart license plate vaults to enter a defensive state. Additionally, if the smart license plate vault that detects tampering is prevented from communicating a last signal regarding its tampering, such as due to a delay in activating the mobile network connection, it can simultaneously broadcast the tampering notification to the mesh network connected smart license plate vaults. One or more of the connected smart license plate vaults can then relay the signal to a user device or remote system so that appropriate actions may be taken in response to the detected tampering. Further, the signal output from the smart license plate vault being tampered with to the other smart license plate vaults nearby can cause the nearby smart license plate vaults to activate their audible alarms to draw attention to the detected tampering.

Power Management

An important aspect of the smart license plate vault is power management, as this will allow the device to function for an extended period of time. A rechargeable battery (such as 114 of FIG. 1) is generally included in the device to provide the power for the various functions and features of the smart license plate vault, such as communications, information transmission and allowing access to the storage compartment. Low-power architecture and circuitry and various power management schemes are generally used to reduce the power usage and allow the battery life to be 3-6 months between charges. However, it should be noted that embodiments can be powered or charged/recharged in other ways such as using non-rechargeable batteries (in which case batteries generally would need to be changed from time to time), by drawing electricity directly from the vehicle (e.g., tied into the vehicle's electrical system), or by including one or more solar panels to generate electricity for the smart license plate vault.

The battery pack is securely retained in the smart license plate vault so as to prevent tampering (see pending patent application U.S. Ser. No. 16/716,407) and can be removed to allow the battery to be recharged externally from the device. Currently, the battery includes a USB Type-C connection to connect the battery to a power source for recharging. The power connection can be isolated from other elements of the smart license plate vault to prevent unauthorized users from using the power connection to attempt to access the smart license plate vault. For environments in which multiple smart license plate vaults are in use, such as in a vehicle fleet, a charger that can recharge multiple batteries at once can be used. Alternative charging methods or connections could also be used to recharge the battery. For example, the battery could be recharged using a kinetic energy recovery system, such as by converting the vibrational energy experienced by the smart license plate vault while on a moving vehicle into electrical energy that charges the battery. In another example, the battery could be charged using an inductive charging system.

Some of the largest power drawing activities by the smart license plate vault are the maintenance and usage of the Bluetooth® and mobile network connections. To preserve power, these connections can be used as needed rather than continuously maintained. Various power management schemes can be used to selectively activate one or more of the connections as needed.

In an example power management scheme, the mobile network connection can be activated in response to various events, such as detected using one or more sensors of the smart license plate vault. The detection of these events can trigger the mobile network connection to become active and for information to be transmitted over the active connection. For example, the mobile connection can be activated when a user lowers the front cover of the smart license plate vault, actuating a switch or sensor that causes the connection to be activated.

In another example, the mobile network connection can be activated based on one more motion triggers, such as detected by an accelerometer or other motion sensor(s) of the smart license plate vault. The detection of the motion can trigger the transmission of location information by the smart license plate vault via the mobile network connection. A tracking algorithm can determine the interval at which such location information is logged and/or transmitted and the mobile network connection can be deactivated while the location information is not transmitted to reduce the power usage. In this manner, the location information is transmitted periodically and the mobile network connection is activated only when needed to transmit the information and is deactivated once the transmission is complete.

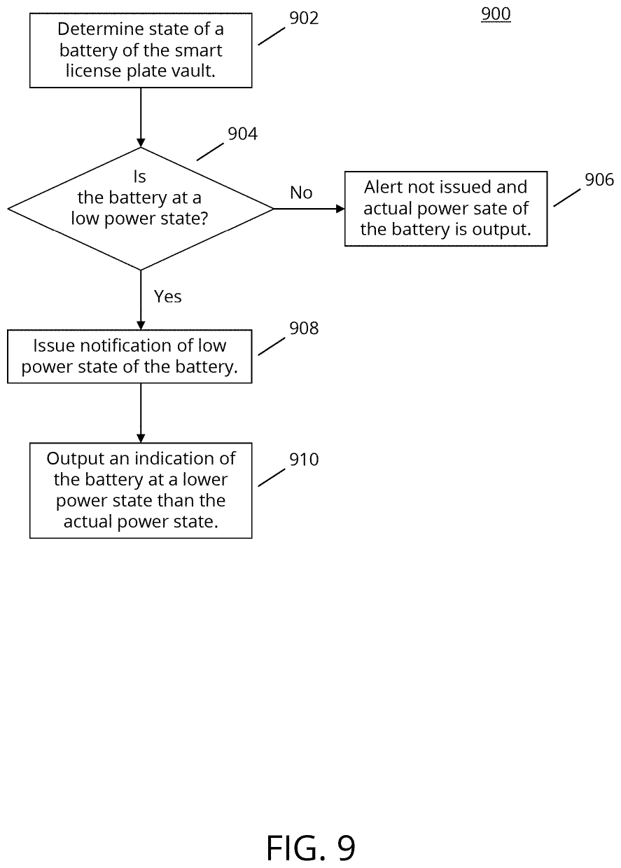

As the ability to unlock and allow access to the storage compartment is primarily dependent on having enough electrical power to actuate the locking mechanism, it is important that the power management of the smart license plate vault reserves enough electrical power to do so. The example method 900 of FIG. 9 illustrates the generation of a low power notification to prompt a user to replace or recharge the battery of a smart license plate vault. At 902, a state of the battery is determined, such as by a processing unit of the smart license plate vault or by a controller of the battery. At 904 a determination is made as to whether the battery has reached a low power state, such as a predetermined low power level. If it is determined that the battery is not in a lower power state, then no notification is issued at 906 and the actual remaining battery is displayed. When it is determined the battery has reached a low power state, the smart license plate vault can provide a notification at 908 to a user device or a remote system that the power state is low and the battery needs to be replaced or recharged. In response to this notification, it is expected that the user will take action to replenish the battery. However, some users may choose to ignore such notifications. To further prompt the user to rectify the low battery charge state, the method 900 can cause an indication to be output at 910 that current battery state is a lower power state than the actual power state of the battery, such as by displaying a lower than actual amount of remaining power in the battery. This indication of an artificially lower power reserve is intended to cause the user to promptly charge the battery at their earliest possible opportunity, so as to not interrupt features or functions of the smart license plate vault, such as the tracking and security features.

Additionally, the low power state of a battery may prevent the tracking and security functions and features of the smart license plate vault from being utilized as desired. For example, the low power state may prevent or impact the ability of the smart license plate vault to accurately report its location and/or movement, meaning the vehicle may be less secure to theft or misuse. Since these features require electrical power, it is important that the battery be maintained at a sufficient level of charging to allow these and other functions and features of the smart license plate vault to continue uninterrupted. As previously discussed, the smart license plate vault can output a notification of the remaining power level. However, if a user or organization continues to ignore such notifications and the remaining battery power reaches a predetermined or critical state, a third-party can be tasked to replace the battery of the smart license plate vault or otherwise service the smart license plate vault to restore power and operation to the device (e.g., recharge the battery). This service can be performed automatically and billed to the smart license plate vault user, as part of the terms of service of the device and supporting system, to ensure that the functions and features of their smart license plate vault usage is uninterrupted. For example, the service provider can task employees or arrange for others to service smart license plate vaults that are providing indications of such low or critical remaining power. Alternatively, such a service can be provided as an optional or subscription-based service that a user can sign up for.

Additionally, the power management can be programmed or structured to ensure that a predetermined amount of power reserve is maintained for select functions or features of the smart license plate vault, such as an ability to allow a single access to the storage compartment and/or power a Bluetooth® beacon. By reserving enough power to allow a user to access the storage compartment one last time, the user can retrieve the stored keys and use the vehicle as needed. This can help to prevent the user from being stranded or without the ability to use the vehicle due to the battery of smart license plate vault being dead or drained. Reserve power can also be used to allow an ultra-wideband (UWB) Bluetooth® beacon to be activated. The UWB Bluetooth® beacon can be used to broadcast a message to a user or other entity (e.g., a service provider or service representative) that the battery of the smart license plate vault is dead and needs to be replaced or recharged. Additionally, the UWB Bluetooth® beacon can allow for limited, local tracking of the vehicle, such as to assist a user (e.g., service representative or other tasked person tasked with battery replacement) in locating the smart license plate vault for which the battery needs to be replaced or recharged.

In some situations, the battery of a smart license plate vault may deplete beyond the predetermined level that was reserved to allow a user a last chance to access the storage compartment. As such, the user would then be barred from accessing the storage compartment and retrieving contents stored within, such as vehicle keys. As a failsafe, the smart vehicle license plate vault can also include an external power connection. A user can connect an external power source to the smart license plate vault using the external power connection to provide electrical power to the smart license plate vault to allow a user to access the storage compartment.

Service Provider and Additional Features

One of the main aspects of the smart license plate vault is that it allows a user to permit another person to easily and securely access the vehicle keys for various purposes, such as providing services to the user. The user can arrange with a service provider and, by using the application and/or services provided by the service provider, grant the service provider access to the vehicle keys so that the prearranged service can be performed. The user can provide a one-time access code the service provider can input on the keypad to retrieve the vehicle keys or can grant the service provider permission to access the user's smart license plate vault, such as through an application on a mobile device of the service provider. Alternatively, a remote operator, such as may be provided or arranged by the service provider, can be permitted by the user to grant the service provider access to the user's smart license plate vault for key retrieval. Service providers may be required to meet certain requirements and/or pay a fee to be affiliated with the service provider and have their services offered through the service provider's application on user devices and/or through a web-based portal.

In an example embodiment, the user can access the service provider's application on their user device or interact with a webpage provided by the service provider to be presented a list of available services that a user can schedule. Example services can include refueling of the vehicle, vehicle maintenance tasks, deliveries, and other services that can be provided to the user through their vehicle or performed on their vehicle. The user can open the service provider application on their user device and can select that they would like a service provider (such as a mechanic or dealership) to come and retrieve their vehicle, drive the vehicle back to their location, perform the requested service and return the vehicle. The user can then grant the service provider access to the stored keys in the smart license plate vault so that the user is not required to interact with the service provider or vehicle to have the requested service performed. This ability is a consumer convenience as they can drive their vehicle to work, have the vehicle retrieved, serviced and returned so that they may then drive it home at the end of the day.

Similarly, the user can arrange to have deliveries made to their vehicle, which may be more secure and/or convenient than having the deliveries made to their house or other physical location. The user can use the service provider application and/or web-based portal to arrange for the delivery to be made to their vehicle. The user can arrange or permit the delivery provider to access the user's smart license plate vault to retrieve the vehicle keys so that the delivery provider can unlock the vehicle and deposit the delivery within the user's vehicle. Additionally, transmitted vehicle location information and the UWB Bluetooth® beacon of the smart vehicle license plate can assist the delivery provider and/or other service providers with locating the vehicle so that the requested services can be performed.

Additionally, since the vehicle movement is monitored using the smart license plate vault, the service provider or affiliated service providers can use such information to prompt or remind the user to perform or request services. For example, oil changes and other regular services are often performed at specific time or mileage travelled intervals. The location data from the smart license plate vault can be logged and tracked to anticipate when such events are upcoming and reminders can be provided to the user through various means, such as pop-up, email or text message notification. The user can then be provided the opportunity to arrange such service with an affiliated service provider, e.g., through the service provider application on the user's device or through a web-based portal provided by the service provider.

Further, the logged vehicle location information can be analyzed and evaluated to provide insights to the user's behavior, which can then be used to recommend or prompt the user for various services. For example, the logged location information can be evaluated to determine how often the user stops to refuel their car, such as based on a time and/or distance travelled between refueling. Using that data, a remote server or system of the service provider can model and predict when the user will next need to refuel and can prompt the user that it may be time to refuel when near the predicted time. The prompt can include the ability to allow the user to schedule a refueling with an affiliated service provider and arrange for the service provider to retrieve the keys from the smart license plate vault so that the service can be performed. In this manner, the user behavior and patterns can also be used for marketing purposes. Various services can be recommended to the user based on their previous behavior or patterns.

Once services are completed, the smart license plate vault can verify that the key has been returned to the storage compartment. The user can be alerted if such verification is not made so they may contact the relevant parties to retrieve or have the vehicle keys returned. The user may also be notified when such verification is successful so that the user has peace of mind that the vehicle's keys have been returned properly. In some embodiments, the smart license plate vault may prompt or remind the service provider to return the vehicle keys to the storage compartment, such as by issuing an audible alert or providing an electronic alert to the service provider's device (e.g., cellphone or other user device).

In another embodiment, the registration of a user's smart license plate vault can include providing a make and model of the user's vehicle to which the smart license plate vault will be attached. This information can be used by the service provider to recommend vehicle services based on the maintenance schedule associated with the user's vehicle. The service provider's remote server/system can include a database of maintenance schedules and can track the mileage and time between vehicle servicing in order to recommend or remind a user of an upcoming service that should be scheduled. The user can be provided an opportunity to schedule such service through the service provider application on the user's device or through a web-based portal provided by the service provider.

Additionally, the location the smart license plate vaults in use can be sold to various marketing and/or consumer analytics data purchasers. To assist with privacy, the data can be anonymized prior to being sold so that particular users cannot be tracked using the sold location data. This is similar to how cell phone location data is currently sold for marketing and analytics purposes.

Additional services and features can be provided by the smart license plate vault using the UWB Bluetooth® beacon. The UWB Bluetooth® beacon can transmit a signal that contains a unique identifier associated with a user's particular smart license plate vault. Readers can receive the signal from the UWB Bluetooth® beacon and perform various actions in response to receiving the signal. For example, a reader can be positioned by the home garage of the user and when it receives the signal from the UW Bluetooth® beacon and confirms the unique identifier associated therewith, can cause the garage door to automatically open. In another example, a gas station may have a reader by each of the gas pumps and can read and identify the UWB Bluetooth® beacon of a vehicle parked at the pump for refueling. The unique identifier can be used to bill the user for the gas purchased. This may be particularly useful for fleet vehicles as it would not require the driver to carry a company fuel card for use when refueling the fleet vehicle and also prevent potential fraudulent refueling at the expense of fleet owners. Similarly, readers could be used to bill or charge the user for other services, such as drive-through food orders, road tolls, parking garage charges and other services.

Additionally, readers positioned at locations can read the UWB Bluetooth® beacon and unique identifier and then communicate with the service provider's remote server or system to cause a push notification to be issued to the user through the user device associated with their smart license plate vault. For example, a user can be driving by a gas station where a reader can identify the vehicle based on the UWB Bluetooth® beacon of the attached smart license plate vault and can indicate to the service provider's remote server or system that the vehicle has just passed by. The service provider's remote server or system can use the user's behavior pattern and historical location information to determine if the user is likely to need refueling. If it is determined that the user is likely to be in need of refueling, the remote server or system can issue a push notification through the service provider application on the user's device. The user can then be provided an opportunity to arrange a refueling service with an affiliated service provider, such as the gas station that originally registered the user's vehicle passing by. In this manner, the user can be provided marketing that is relevant to their current needs and/or location.

Bluetooth® beacon readers can also be positioned within a geographical area to further assist in tracking smart license plate vault equipped vehicles as they move through the geographical area. The collected location information can be used in manner similar to the location information that is received from the smart license plate vault through the mobile network and can also assist with locating a vehicle within the geographical area in a means that does not rely on the smart license plate connecting to the mobile network.

Fleet Management

The functions and features of the smart license plate vault can also assist vehicle fleet managers with managing, maintaining and collecting data regarding a vehicle fleet that has attached smart license plate vaults. A fleet manager can collect location data to determine where vehicles are located, the manner in which the vehicles are being used, and other relevant information regarding the use of the fleet vehicles. Such information can be analyzed to generate information regarding vehicle usage that can be used to inform decision-making processes regarding the vehicle fleet. Additionally, keys for a particular vehicle can be stored in the attached smart license plate vault, making locating and retrieving the vehicle keys easier.

In an example embodiment, a car dealership can affix smart license plate vaults to their available vehicles to store the keys associated with each vehicle rather than having the keys located in a central lockbox. Oftentimes, sales people may forget to retrieve the keys prior to escorting customers onto the lot and to a prospective vehicle. With the smart license plate vault, the salesperson does not have to run to a key storage location and retrieve a key while the customer waits, instead the salesperson can just retrieve the keys from the attached smart license plate vault. This also helps with managing the vehicle keys as the salesperson can be prompted or reminded to return the keys to the smart license plate vault, ensuring the requisite key remains with a specific vehicle. Additionally, the smart license plate vault can log and provide access history data to the dealership, allowing them to monitor for potential non-approved usage of the vehicles.

Fleet managers can also use the historical vehicle usage data to assist with making decisions regarding the fleet, such as when vehicles need to be replaced, a preference or use of a particular type of vehicle, where vehicles should be staged or located and/or other decisions. In the example of a car dealership, they can track customer test drives of vehicles to rank the popularity of their offerings and also track test drives versus sales to determine how many test drives of a particular model are converted into sales. This and other types of analysis of vehicle usage can assist the car dealership with making decisions regarding vehicle inventory and provide insight into consumer vehicle preferences.

Oftentimes, fleet vehicles are parked in large lots next to other fleet vehicles, which can make identifying a particular fleet vehicle difficult and also make it difficult to track the available fleet inventory. One or more Bluetooth® beacon readers can be positioned about the fleet storage area to receive UWB Bluetooth® beacon signals from the smart license plate vaults attached to the fleet vehicles. The collected UWB Bluetooth® beacon data can be used to determine a current inventory of the vehicle fleet present in the fleet storage area, so that users are not directed to a vehicle that is not present or is unavailable. Additionally, the collected UWB Bluetooth® beacon data can be used to assist in guiding users to a particular vehicle of the fleet, so that the user is not wasting time while trying to locate the vehicle. This can be particularly useful in car rental situations, where renters may not be able to accurately identify the particular vehicle they have been assigned. Similarly, at car dealerships, the ability to track the inventory in real-time prevents a salesperson from offering a test drive for a vehicle that is currently unavailable.

User Application and Web Portal

As discussed above, users interact with the smart license plate vault through an application installed on a mobile device (e.g., cellphone, tablet, etc.) or through a web-based portal. Through these access methods, users can view smart license plate vaults that they are associated with, details regarding each of the smart license plate vaults, permit access to other users and other information and configuration settings regarding smart license plate vaults and the vehicles they are attached to.

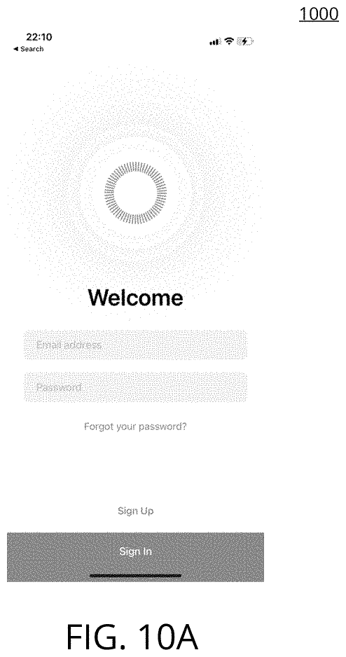

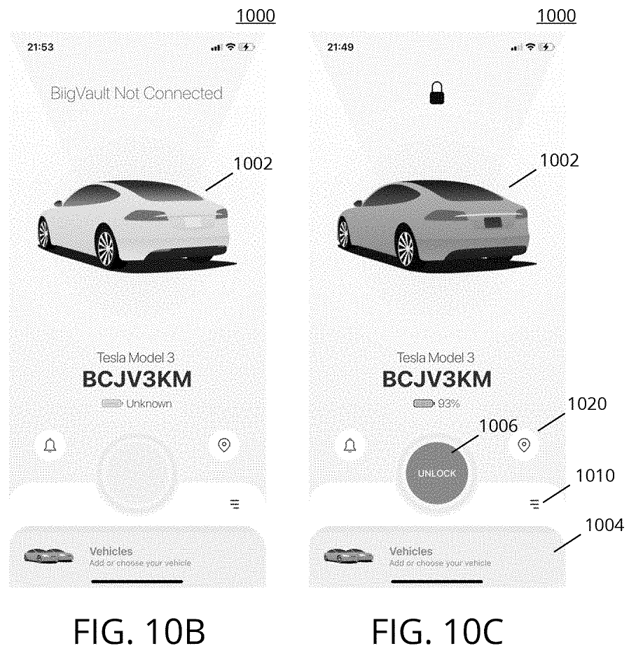

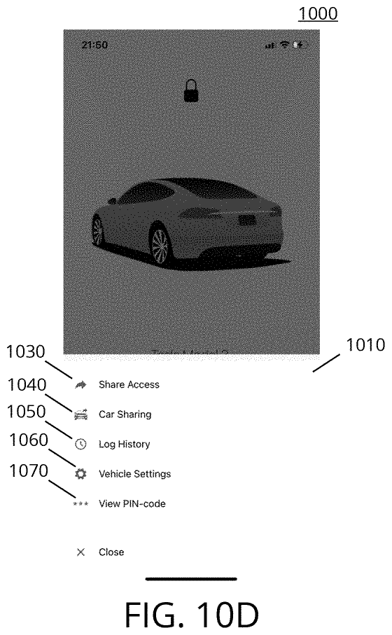

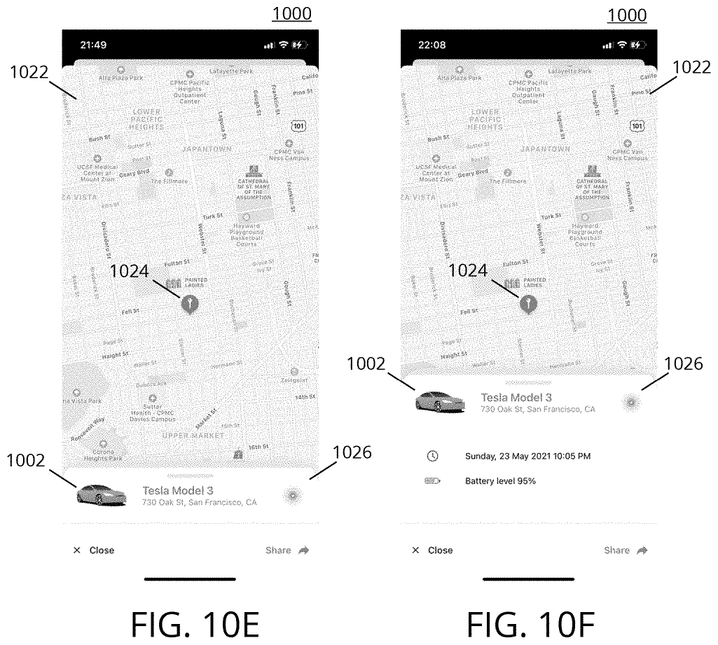

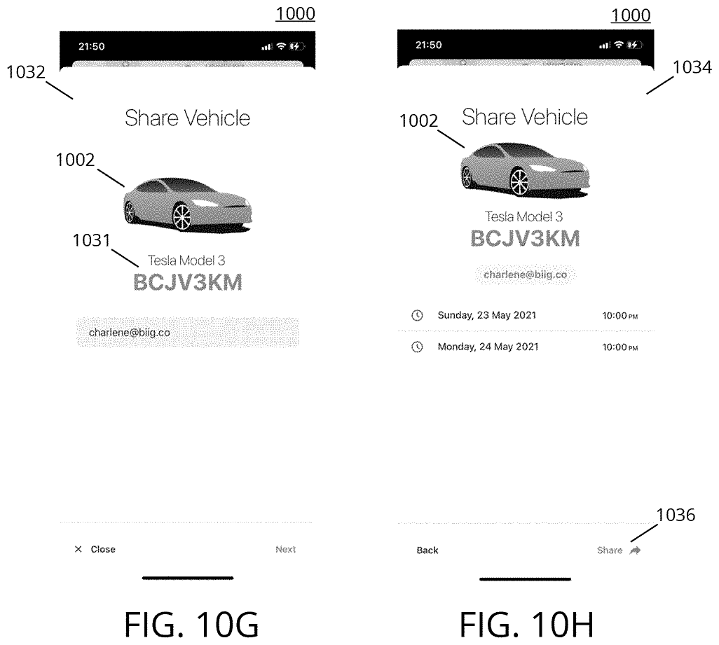

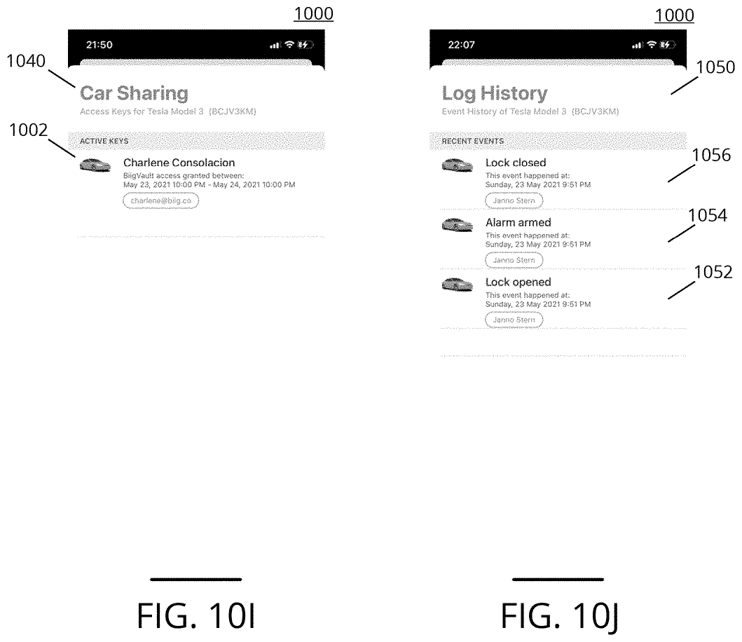

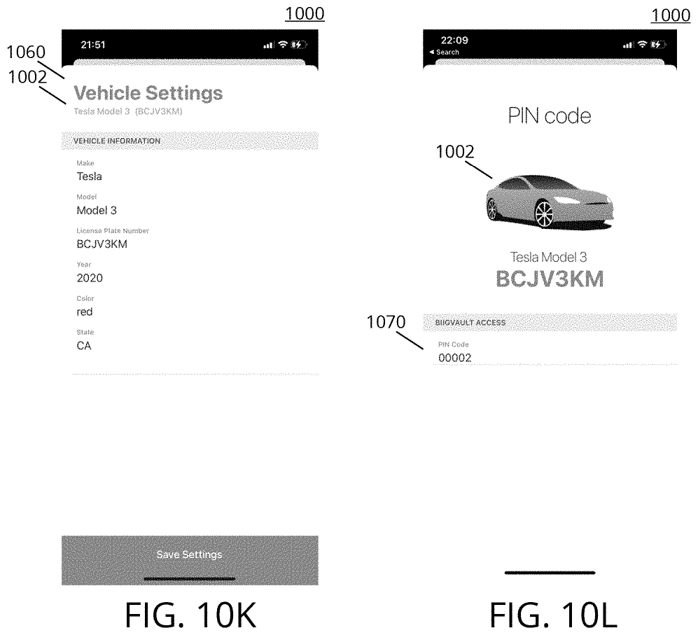

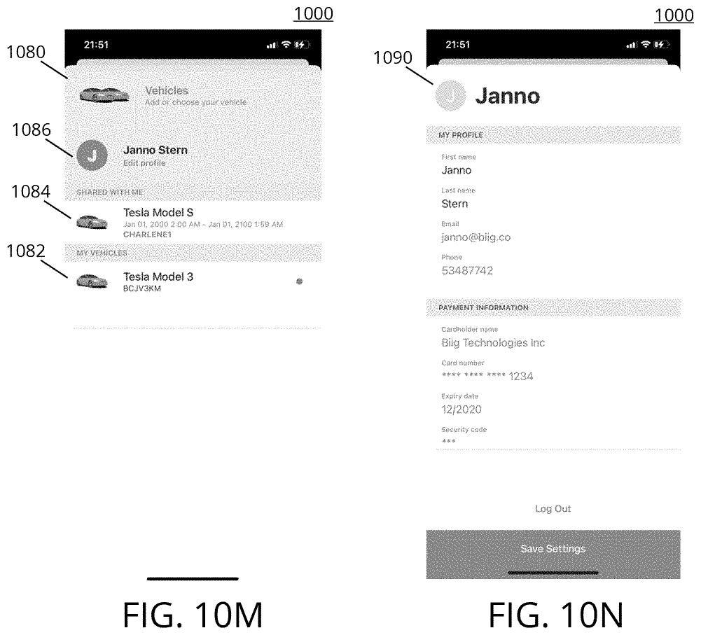

FIGS. 10A-10N are screenshots of an example application 1000 that a user can use to interact with the smart license plate vault. In FIG. 10A, the user is presented with a login screen for them to provide credentials. The user-provided credentials can be verified on the device, at a remote system/device to which the credentials are transmitted or a combination thereof. Once authenticated, the user can be presented with a screen showing information regarding a smart license plate vault and vehicle 1002 with which the user is associated, such as by the owner or manager of the vehicle. FIGS. 10B and 10C show two such screens, where FIG. 10B illustrates that the user device is not currently connected to the smart license plate vault that is associated with the vehicle and FIG. 10C illustrates that the user device is currently connected to the smart license plate vault. As previously discussed, the smart license plate vault and user device can communicate via a local Bluetooth® connection and/or through a mobile data connection. If the user device is not able to connect to the smart license plate device, the user can be presented the screen shown in FIG. 10B, indicating to the user that they are currently unable to interact with the smart license plate vault. Additionally, if the user device is unable to connect to the smart license plate vault, the user may be unable to view information, such as a current location, battery status, and/or other information regarding the smart license plate vault and associated vehicle. If the user device is able to connect to the smart license plate vault, the user can be presented the screen of FIG. 10C and can then interact with and view information regarding the smart license plate vault and/or associated vehicle. In either of the screens, such as shown in FIGS. 10B and 10C, the user can select a tab 1004 to pull up a menu of other vehicles and accompanying smart license plate vaults with which the user is associated (i.e., allow the user to switch between smart license plate vaults). In FIG. 10C, with the user device connected to the smart license plate vault, the user can select unlock 1006 to cause the smart license plate vault to unlock and permit the user or another person to access the contents stored within, such as keys of the vehicle 1002. As discussed above, commands issued to the smart license plate vault through the application 1000 are signed by either a remote server/system or through use of a stored token. Additionally, the user can access the menu 1010 to interact with other features and/or settings regarding the smart license plate vault or the location button 1020 to view the current location of the smart license plate vault and vehicle 1002.

FIG. 10D illustrates the options of menu 1010. The user can select to share access to the vehicle 1030, view accesses that have been granted 1040, view event log history 1050, view vehicle information/settings 1060 and view the pin code 1070 for the currently selected smart license plate vault.

FIGS. 10E and 10F illustrate the location information screens 1022 that are shown when the user selects the location button 1020. In FIG. 10E the user is shown the current location of the smart license plate vault equipped vehicle 1002. The location is indicated by a pin 1024 and a card 1026 is displayed showing information regarding the vehicle 1002 the selected smart license plate vault is associated with. The card 1026 can show the vehicle make/model or a name of the vehicle and a street address of the vehicle location. The user can select or interact with the card 1026 to view additional information regarding the vehicle 1002, as shown in FIG. 10F. The additional information can include the battery status of the smart license plate vault and the time at which the vehicle was positioned at the current location.

FIGS. 10G and 10H illustrate the vehicle sharing 1030 accessible through menu 1010. When the user selects to share the vehicle 1002, the user can be presented a first screen 1032 shown in FIG. 10G. In this first screen 1032, the user is presented information 1031 regarding the vehicle 1002 to indicate the vehicle 1002 that is to be shared. The user is asked to provide information to identify the person with whom they would like to grant access to the vehicle 1002 via the smart license plate vault. The user. Such information can include an email address (as shown), phone number or other unique identifier of another user/person. Once entered, the user can proceed to the second screen 1034 shown in FIG. 10H. In the second screen 1034, the user can set various settings regarding the sharing of the vehicle 1002. In the example shown in FIG. 10H, the user can select a time period that the vehicle sharing 1030 is active for. In another embodiment, the user may be permitted to provide a geofenced area in which the vehicle can be used, and/or input other or additional parameters/settings regarding the sharing of the vehicle 1002. During this period, the person granted permission will be allowed to access the smart license plate vault to access the keys and to use the vehicle 1002. Once the user has identified the person with which they would like to share the vehicle 1002 with and has provided the parameters regarding the sharing, the user can select share 1036 to confirm the sharing of the vehicle 1002.

FIG. 10I illustrates a screen showing vehicle accesses that have been granted 1040. In this screen, the user can see the permissions for use of the selected vehicle 1002 that have been granted to other users/people, such as through the sharing process 1030 shown in FIGS. 10G and 10H.

FIG. 10J illustrates a screen showing the event log history 1050 of the selected smart access license plate vault. Here the user can view the various events regarding the selected smart license plate vault, such as when the smart license plate vault was opened 1052, when the alarm was armed 1054, when the smart license plate vault was closed 1056 and/or other events. Other events can include the alarm of the smart license plate vault being activated or going off, such as in response to one or more sensors detecting an intrusion attempt. Further, other events can include location or speed events, such as stops the vehicle 1002 made and for how long and if the vehicle exceeded a predetermined speed limit. In an example, the logging of such events may be controlled by the user through the application or web-based portal, such as by the user providing one or more parameters regarding such events that causes the event to be logged.

FIG. 10K illustrates a screen showing vehicle information 1060 regarding the vehicle 1002 associated with the selected smart license plate vault. The vehicle information 1060 can include a make/model, license plate, registration information and/or other information 1060 regarding the vehicle 1002. The vehicle information 1060 can be populated by the user, such as by providing such information through the application 1000 or through the web-based portal 800. In an example embodiment, the vehicle information 1060 can be retrieved from relevant databases or a combination of manually input and retrieved data to populate the vehicle information 1060.

FIG. 10L illustrates the screen showing the pin code 1070 of the selected smart license plate vault. The user can enter the pin code manually into the smart license plate vault to obtain access to the contents stored within. In an example, the user may have the option to change or generate a random pin code that can be used to access the smart license plate vault. In another example, the pin code can be a time-based code that changes regularly, such as a rolling code.

FIG. 10M illustrates an example user profile screen 1080 that can be accessed by selecting the tab 1004. In this screen the user can see the various vehicles they manage 1082 via accompanying smart license plate vaults and vehicles that they have been granted permission to use 1084. Additionally, the user can edit their profile by selecting 1086. If the user wishes to view information regarding another vehicle and accompanying smart license plate vault, they may do so through the screen 1080 by selecting the vehicle from the list of vehicles they manage 1082. In this manner, the user can manage access and view information regarding multiple vehicles through the application and the accompanying smart license plate vaults.

FIG. 10N illustrates the user profile edit screen 1090. In this screen, the user can provide or edit various information regarding themselves, such as a name, email, phone number and/or other user information. Additionally, they can also provide payment information which can be used to pay a subscription fee(s) associated with the smart license plate vaults the user manages, pay for vehicle sharing fees (e.g., rental cost) and/or other payment processes that are performed through or as a service by the application and/or company/manufacturer that provides the smart license plate and associated services.

Various information displayed in the application 1000 can be provided by the user through the application 1100 or provided through the web-based portal 1100 as described below. In this manner, the application 1000 and the web-based portal 1100 can be used in conjunction to manage and configure one or more smart license plate vaults and access permissions and user(s) associated therewith.

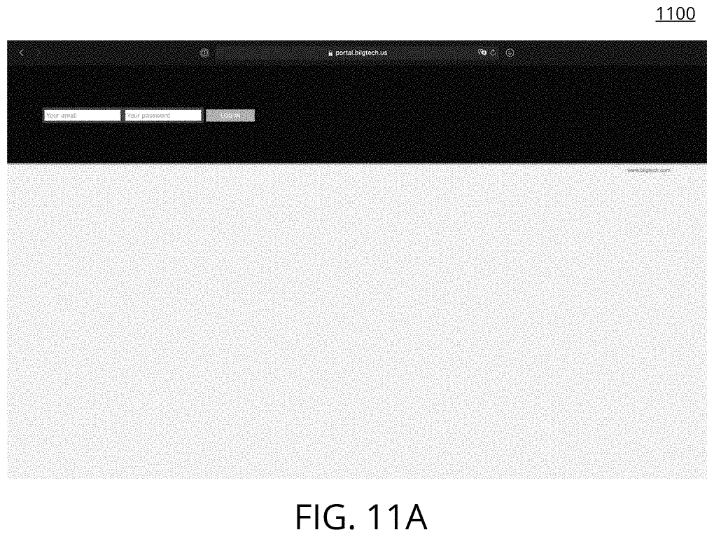

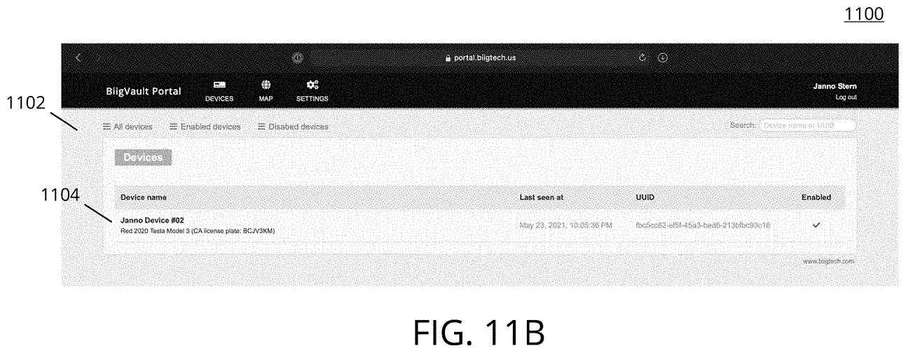

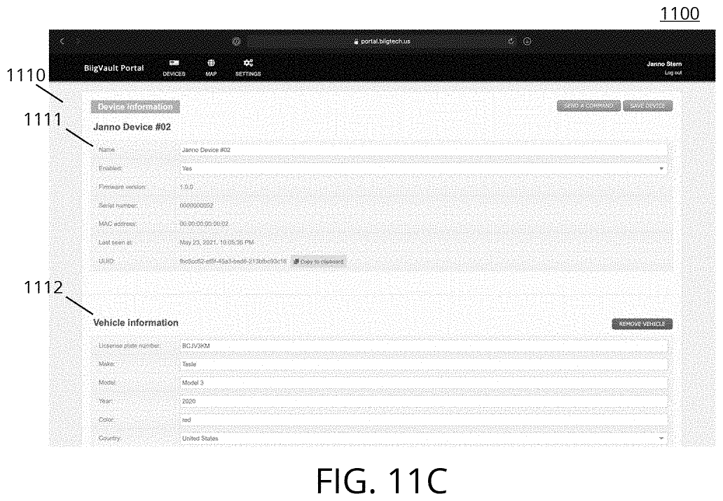

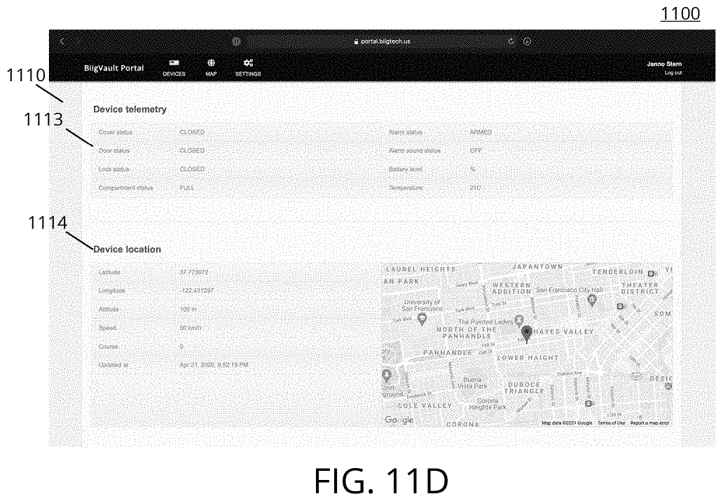

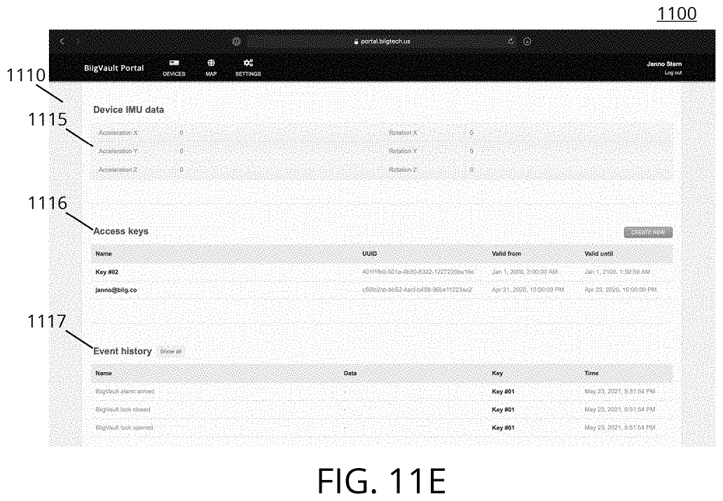

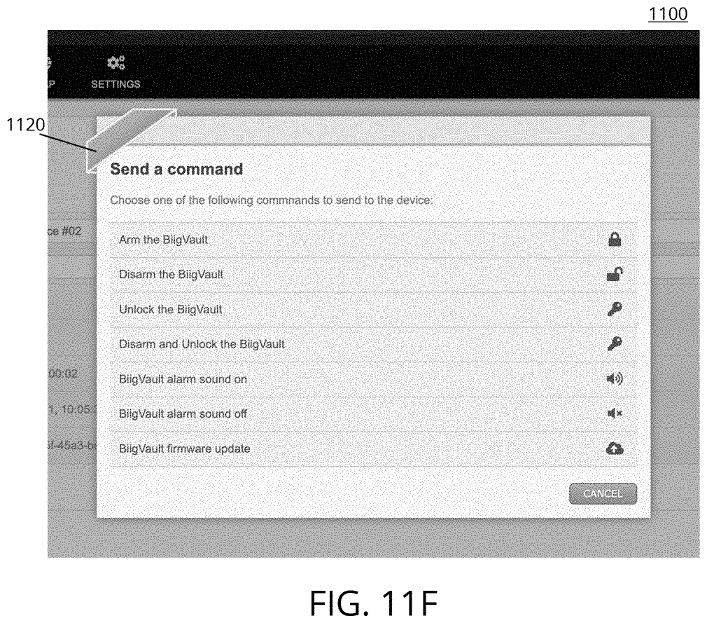

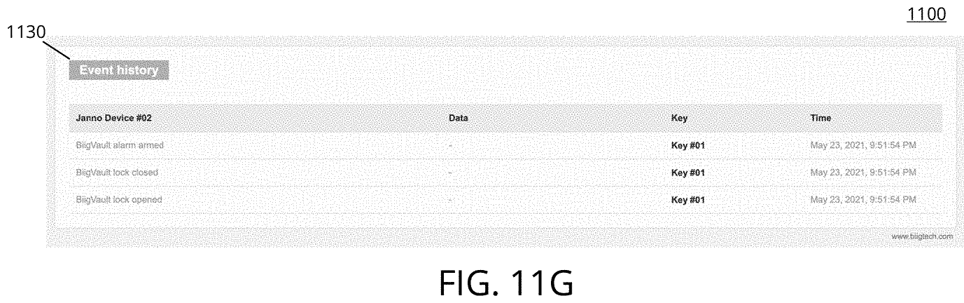

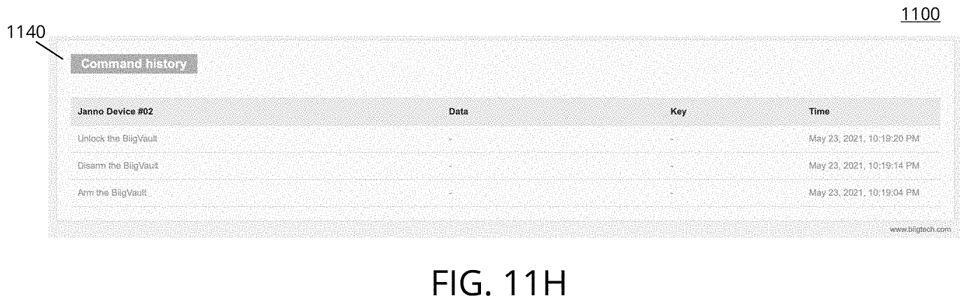

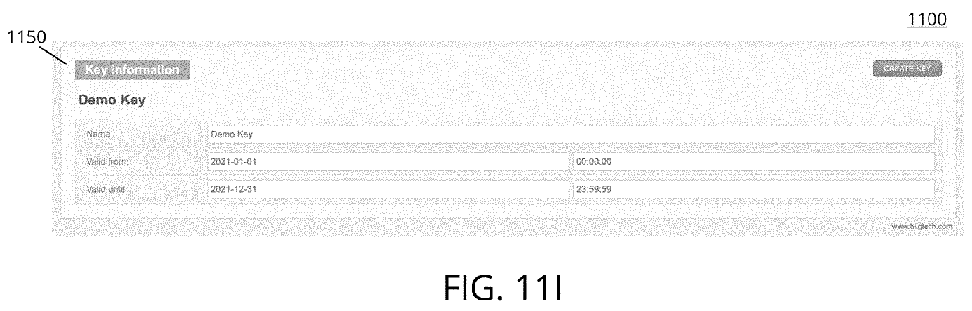

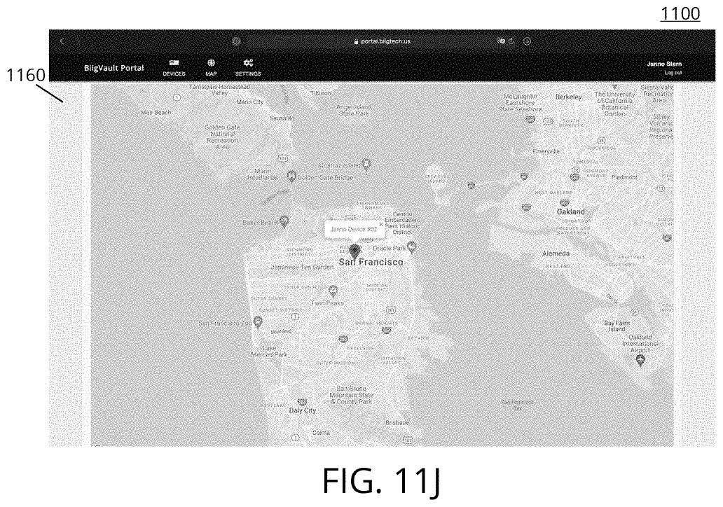

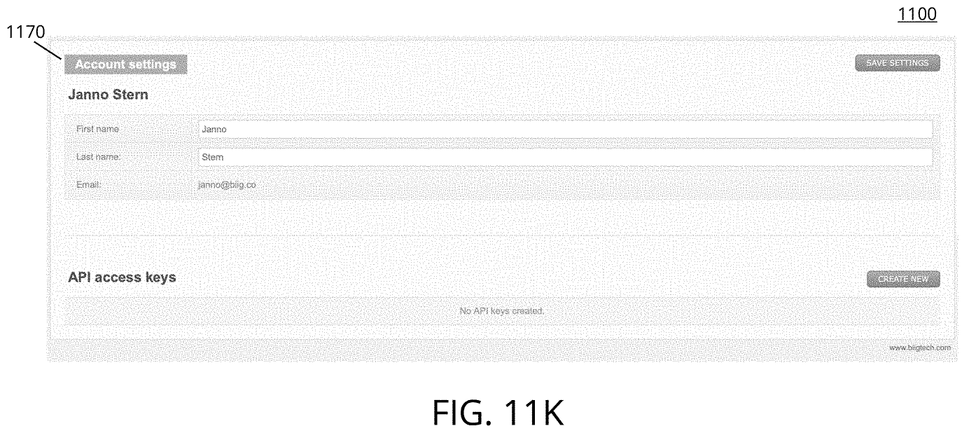

FIGS. 11A-11K are screenshots of an example web-based portal 1100 that a user can use to access, manage and oversee a vehicle(s) equipped with a smart license plate vault that is associated with the user. FIG. 11A illustrates a login screen through which the user can provide credentials to access the web-based portal 1100. Once authenticated, the user can be presented an overview screen 1102 shown in FIG. 11B, that lists the various smart license plate devices 1104 that are associated with the user. The user can be provided options to sort or filter the listed devices 1104, such as to show all devices, the enabled devices, or the disabled devices. Further, the user can be provided selections to access other information regarding the devices 1104, such as a map showing the location of the listed devices, and access to settings for the web-based portal 1100. In the listing of the smart license plate devices 1104 shown in FIG. 11B, the user can view information regarding each of the smart license plate devices, such as the name of the device, the vehicle associated with the device, when the device last provided information/communicated with a server, a unique ID associated with the device and whether the device is enabled or not. To interact with a specific device, the user can select a particular device from the list 1104.

FIGS. 11C-11E illustrates a device details screen 1110, that can be viewed by selecting a smart license plate device from the list 1104 shown in FIG. 11B. In the device details screen 1110, the user can view details 1111 of the smart license plate vault, information 1112 regarding the vehicle associated with the smart license plate device, information 1113 regarding the status of the smart license plate device, location data 1114 of the smart license plate device, inertial motion unit information 1115, information 1116 regarding shared access to the smart license plate vault, and event history 1117. The user can edit some details 1111 of the smart license plate device, such as a name and whether the device is enabled or not. Additionally, the user can view details regarding the smart license plate device, such as its serial number, MAC Address, when the smart license plate was last seen (i.e., when the last information was received from the smart license plate device), and unique ID.

In the vehicle information 1112, the user can provide or edit details regarding the vehicle associated with the selected smart license plate device. The user can provide make, model, license plate, and/or other information regarding the vehicle. Additionally, the user may be provided the option to clear the information, such as when wanting to move the smart license plate device to another vehicle. In another example, the user may be provided a means of selecting a particular vehicle from a list of stored vehicles, in this manner the user can quickly and easily associate the selected smart license plate vault device with a particular vehicle, such as a particular vehicle of a fleet of vehicles.

The device status information 1113 can show various information regarding the current status of the selected smart license plate device, such as whether the device is currently locked, whether the door has been closed, whether there is anything stored within, whether the alarm is armed, the battery status, temperature and/or other information regarding the status of the smart license plate device. In an example, the user may be presented an option to view photos of the compartment along with the status of the compartment, to confirm that the status is correctly indicated (e.g., confirm the keys are actually within the compartment when so indicated).

The location data 1114 can show details regarding the current location of the selected smart license plate device and accompanying vehicle. This can include a map display, showing the location of the smart license plate on a map. Additionally, the user can also be presented a time stamp indicating when the vehicle was first placed at the indicated position to allow the user to determine how long the vehicle has been at the current position. As previously discussed, the location data 1114 can be provided by one or more position/location sensors (e.g., GPS) located on the smart license plate device and then transmitted to a server/system that provides such information through the web-based portal 1100.

The inertial motion unit (IMU) data 1115 can provide current information regarding motion of the smart license plate device. This information can be used to monitor the travel of the associated vehicle, such as for monitoring the driving of a vehicle user.

The shared access information 1116 shows the various access keys that are currently active to grant access to the smart access license plate vault. Details regarding each access can be viewed and selecting an access can allow a user to view further details and/or edit an access. Additionally, the user can also create a new access to grant access to another user access to the selected smart license plate vault.

The event log 1117 shows various events that have been generated/logged by the selected smart license plate vault, such as access events, alarm events, and/or other events. The user can view these events and associated details. In an example, when the compartment of the smart license plate vault has been accessed, a photo can be taken and included in/attached to the logged event in the event log 1117. Additionally, each logged event can include an identifier that associates the event with one of the granted accesses. In this manner, the user can identify which other person triggered the particular event, such as which person with granted access opened the smart license plate vault to access the vehicle keys at a particular time. In another example, the user may be provided an option to save and/or export the event log 1117. Additionally, the user may have controls to sort or filter the event log 1117.

While viewing the details of the selected smart license plate vault, the user can select to send a command 1120 to the smart license plate vault, as shown in FIG. 11F. The user can select a command from the list of commands and the selected command is then transmitted to the selected smart license plate vault. For example, the user can select to lock or arm the selected smart license plate vault remotely, such as if the user or another user who has been granted access has forgotten to do so. Commands issued via the web-based portal 1100 are first signed, such as by a server/system supporting the web-based portal, before being transmitted to the smart license plate vault, as described above. Additionally, the user can trigger an over-the-air update to the selected smart license plate device to cause the selected smart license plate device to update its firmware.

FIG. 11G illustrates an example event viewer 1130. From the device details screen 1110, the user can select to view more or all events from the event log 1117 and can be presented the event viewer 1117. The user can view a longer or complete history of events associated with the selected smart license plate device and may be able to export, save, sort and/or filter the events. In an example, the user may be allowed to select an event to view additional information regarding the event, such as a location of the smart license plate when the event occurred, various sensor data of the event and/or other details/information regarding the selected event.

FIG. 11H illustrates an example command viewer 1140 where the user can view the commands that were previously sent to the smart license plate device. The commands listed can include those provided by the user through the command screen 1120 of FIG. 11F, and commands transmitted through the application 1000 to the selected smart license plate device. In this manner, the user can view a comprehensive listing of the record of commands sent to the smart license plate device. Each listed command can include details, such as what the command instructed, when the command was issued, who issued the command (e.g., which user granted access issued the command) and/or other details regarding the command. In an example, the record of the issued commands, or a selected portion thereof, can be saved, exported, sorted, filtered, and/or cleared by the user.

FIG. 11I illustrates an example access creation screen 1150. Through this interface the user can grant access to another person, allowing them to access the selected smart license plate device. The user can create a name for the access, parameters for the access (e.g., valid time period, geofenced area, etc.) and other details for the access, such as identifying the person or user with which the access is to be granted. Alternatively, the user can create the access as a profile and then later associate that access profile with an identified person to grant them such access. This means of granting access may be desirable in situations where multiple people will be granted the same access. However, in another alternative, the created access can be identified with multiple people. Further, in the access information 1116, the user can be permitted to select an access to edit one or more parameters via an interface similar to the access creation 1150.

FIG. 11J illustrates the map view 1160 that the user can select to show all of their associated smart access license plate devices on a map. In this manner, the user can quickly view the location of all their associated devices. The display of the smart license plate devices in the map view can be filterable by a user, such by a particular device, a characteristic of the device (e.g., enabled or not), or details associated with the device (e.g., who has been granted access, particular vehicle types, etc.). Each of the smart license plate devices shown on the map view 1160 may be selectable by the user to view further details. When selected, the displayed details of a smart license plate device may be limited and the user can then select to view additional details, such as those shown in FIGS. 11C-11E.

FIG. 11K illustrates a user settings interface 1170. In this interface, the user can provide and edit various details regarding themselves, such as their name, contact information, payment information and/or other user information. Additionally, the user can be permitted to create API access keys to allow the web-based portal 1100 to interact with other programs. For example, the user may create an API that allows another application to access information, functions and/or features of the web-based portal 1100.

It should be noted that headings are used above for convenience and are not to be construed as limiting the present invention in any way.

In the foregoing description, certain aspects and embodiments of the invention may be applied independently and some of them may be applied in combination as would be apparent to those of skill in the art. For the purposes of explanation, specific details are set forth in order to provide a thorough understanding of embodiments of the invention.

The foregoing description provides exemplary embodiments only, and is not intended to limit the scope, applicability, or configuration of the disclosure. Rather, the forgoing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Although specific details are given to provide a thorough understanding of at least one embodiment, it will be understood by one of ordinary skill in the art that some of the embodiments may be practiced without disclosure of these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method, a process or an algorithm performed by a processor, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The terms “computer-readable medium”, “memory”, “storage medium”, and “data storage device” includes, but is not limited to, portable or non-portable electronic data storage devices, optical storage devices, and various other mediums capable of storing, containing, or carrying processor-executable instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM, ROM, flash memory, solid state disk drives (SSD), etc. A computer-readable medium or the like may have stored thereon code and/or processor-executable instructions that cause a processor or a device in whole to perform a method, algorithm, procedure, function, subprogram, program, routine, subroutine, or any combination of instructions, data structures, or program statements.

Furthermore, embodiments may be implemented by hardware, software, firmware, middleware, microcode, hardware description languages, or any combination thereof. When implemented in software, firmware, middleware or microcode, the program code, i.e., “processor-executable instructions”, or code symbols to perform the necessary tasks (e.g., a computer-program product) may be stored in a processor-readable or machine-readable medium. One or more processors may perform the necessary tasks.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims.

Without limitation, potential subject matter that may be claimed (prefaced with the letter “P” so as to avoid confusion with the actual claims presented below) includes:

P1. A method comprising detecting an attempt to access the storage compartment of a smart license plate vault (e.g., detecting that an access cover has been opened), activating a mobile network connection to a remote server, communicating with the remote server, verifying a user login to the remote server, granting user access to the remote server (e.g., display the smart license plate vault that access attempt has been detected and provide user list of available smart license plate vaults, which also can display the location of smart license plate vaults), generating a command to access the storage compartment of the smart license plate vault, signing the command, transmitting the signed command to the smart license plate vault, verifying the command by the smart license plate vault (e.g., verifying based on the signature), and granting access to the storage compartment upon successful verification (e.g., unlocking the storage compartment to provide access to stored vehicle keys).

P2. A method comprising receiving data from one or more sensors of a smart license plate vault, analyzing the received sensor data to determine if tampering is indicated, and if tampering is indicated, at least one of initiating a defensive state of the smart license plate vault, transmitting an alert that tampering is occurring (e.g., to a user device, to a remote server/system or operator, to an emergency service, etc.), or generating an audible alarm via an output device of the smart license plate vault, wherein an alert can provide information such as contact information for the smart license plate vault and/or the location of the smart license plate vault and in some cases can include a preformatted message that is completed with location information.

P3. A method according to P2 further comprising activating a mobile network connection; transmitting at least one of sensor data, an indication of tampering, or an indication of initiation of the defensive state for analysis of tampering by a remote server/system or operator; monitoring for notifications from the remote server/system or operator relating to tampering status; if tampering status indicates that tampering is occurring or if no such tampering status is received within a predetermined amount of time, then take further defensive action; or if tampering status indicates that tampering is not occurring, deactivating any defensive state.

P4. A method comprising determining a state of a battery of a smart license plate vault; determining if the battery is at a low power state; if the power state is not low then a low power state notification is not issued (in which case a remaining battery indicator can show actual battery state); and if the power state is low then a low power state notification is issued (in which case a remaining battery indicator can show a lower than actual battery state). In any case, an optional external power connection can be provided to allow the smart license plate value to be connected to an external power source.

P18. A user device for accessing a smart license plate vault, the user device comprising a local transceiver and a processor in communication with the local transceiver and coupled to a memory containing instructions executable by the processor to cause the processor to establish a communication connection with the smart license plate vault; receive a user request to access the vault; generate a signed command to access the vault; and transmit the signed command to the smart license plate vault via the communication connection.

P19. A user device according to claim P18, wherein the smart license plate vault and the user device perform an initial pairing including an exchange of public keys via the communication connection.

P20. A user device according to claim P18, wherein the communication connection comprises a Bluetooth® communication connection.

P21. A user device according to claim P18, wherein the user device authenticates the user and only generates the electronically/digitally signed command upon determining that the user is authentic.

P22. A user device according to claim P21, wherein the user device authenticates the user by at least one of a username/password, a fingerprint scan, a challenge, or two-factor authentication.

P23. A user device according to claim P18, wherein the user device generates the electronically/digitally signed command to access the vault by generating a command and sending the command to a remote server that signs the command and returns the signed command to the user device.

P24. A user device according to claim P18, wherein the user device generates the electronically/digitally signed command to access the vault by generating a command and signing the command using a token stored on the user device.

P25. A user device according to claim P18, wherein establishing a communication connection with the smart license plate vault, receiving a user request to access the vault, generating a signed command to access the vault, and transmitting the signed command to the smart license plate vault via the communication connection are performed by an app running on the user device.

P26. A computer program product comprising a tangible, non-transitory computer readable medium having embodied therein computer program instructions which, when executed on a process of a user device, cause the user device to establish a communication connection with a smart license plate vault; receive a user request to access the vault; generate a signed command to access the vault; and transmit the signed command to the smart license plate vault via the communication connection.

We claim:

1. A system comprising:
a smart license plate vault comprising a base portion, the base portion comprising a vault, an electronic locking mechanism for selectively locking and unlocking the vault, a local transceiver, and a processor in communication with the electronic locking mechanism and the local transceiver for operating the smart license plate vault; wherein:
the smart license plate vault establishes a communication connection with a user device via the local transceiver of the smart license plate vault; and
the smart license plate vault receives a digitally signed command to access the vault from the user device via the communication connection, verifies authenticity of the digitally signed command, and unlocks the vault only upon determining that the digitally signed command is authentic.

2. A system according to claim 1, wherein the smart license plate vault performs an initial pairing with the user device including an exchange of public keys via the communication connection.

3. A system according to claim 1, wherein the communication connection comprises a Bluetooth communication connection.

4. A system according to claim 1, further comprising the user device, wherein the user device authenticates the user and only generates the digitally signed command upon determining that the user is authentic.

5. A system according to claim 4, wherein the user device authenticates the user by at least one of a username, a password, a fingerprint scan, a challenge, or two-factor authentication.

6. A system according to claim 1, further comprising the user device and a remote server, wherein the user device generates the digitally signed command to access the vault by generating a command and sending the command to the remote server that digitally signs the command and returns the digitally signed command to the user device.

7. A system according to claim 1, further comprising the user device, wherein the user device generates the digitally signed command to access the vault by generating a command and digitally signing the command using a token stored on the user device.

8. A method comprising:
establishing a communication connection between a smart license plate vault and a user device via a local transceiver of the smart license plate vault;
receiving, by the user device, a user request to access the vault;
generating, by the user device, a digitally signed command to access the vault and transmitting the digitally signed command to the smart license plate vault via the communication connection; and
verifying, by the smart license plate vault, authenticity of the digitally signed command and unlocking the vault only upon determining that the digitally signed command is authentic.

9. A method according to claim 8, wherein the smart license plate vault and the user device perform an initial pairing including an exchange of public keys via the communication connection.

10. A method according to claim 8, wherein the communication connection comprises a Bluetooth communication connection.

11. A method according to claim 8, wherein the user device authenticates the user and only generates the digitally signed command upon determining that the user is authentic.

12. A method according to claim 11, wherein the user device authenticates the user by at least one of a username, a password, a fingerprint scan, a challenge, or two-factor authentication.

13. A method according to claim 8, wherein the user device generates the digitally signed command to access the vault by generating a command and sending the command to a remote server that digitally signs the command and returns the digitally signed command to the user device.

14. A method according to claim 8, wherein the user device generates the digitally signed command to access the vault by generating a command and digitally signing the command using a token stored on the user device.

15. A smart license plate vault comprising:
a base portion, the base portion comprising a vault, an electronic locking mechanism for selectively locking and unlocking the vault, a local transceiver, and a processor in communication with the electronic locking mechanism and the local transceiver and coupled to a memory containing instructions executable by the processor to cause the processor to:
establish a communication connection with a user device;
receive, from the user device, a digitally signed command to access the vault via the communication connection;
verify authenticity of the digitally signed command; and
unlock the vault only upon determining that the digitally signed command is authentic.

16. A smart license plate vault according to claim 15, wherein the smart license plate vault and the user device perform an initial pairing including an exchange of public keys via the communication connection.

17. A smart license plate vault according to claim 15, wherein the communication connection comprises a Bluetooth communication connection.
